(19) United States
(12) Patent Application Publication
(10) Pub. No.: US 2023/0186647 A1
(43) Pub. Date: Jun. 15, 2023

(54) FEATURE EXTRACTION FROM MOBILE LIDAR AND IMAGERY DATA

(71) Applicant: Anditi Pty Ltd, Newcastle West, NSW (AU)

(72) Inventors: Kaushik MAHATA, Wallsend, NSW (AU); Md Mashud HYDER, Warabrook, NSW (AU); Peter JAMIESON, Mount Vincent, NSW (AU); Irene WANABY, Waratah, NSW (AU)

(21) Appl. No.: 17/916,241

(22) PCT Filed: Mar. 30, 2021
(86) PCT No.: PCT/AU2021/050281

§ 371 Date: Sep. 30, 2022

(30) Foreign Application Priority Data
Mar. 30, 2020 (AU) 2020202249

(51) Int. Cl. G06V 20/56; G06V 10/26; G06V 10/764; G06V 10/56; G06T 7/12; G06T 7/60; G06T 3/40; G06T 7/11; G06V 10/74; G06V 10/44

(52) U.S. Cl. CPC G06V 20/588; G06V 10/26; G06V 10/764; G06V 10/56; G06T 7/12; G06T 7/60; G06T 3/40; G06T 7/11; G06V 10/74; G06V 10/44; G06T 2207/10028; G06T 2207/30256

(57) ABSTRACT

Processes for automatically identifying road surfaces and related features such as roadside poles, trees, road dividers and walls from mobile LiDAR point cloud data. The processes use corresponding image data to improve feature identification.

### TECHNICAL FIELD

The present invention relates to the extraction of features, for example the identification and characterisation of roads and roadside features, from mobile LIDAR data and image data.

The present application claims priority from Australian Patent Application No 2020202249. the entirety of which is hereby incorporated by reference.

### BACKGROUND OF THE INVENTION

There is an increasing requirement for providing detailed mapping and feature identification for many applications. One specific area of increased focus is the provision of detailed data in which road surfaces and roadside features are characterised.

One example is the agreement by the UN to focus on having at least 75% of travel on 3 star or higher rated roads by 2030, as a sustainable development goal. The system is explained, for example, at https://www.irap.orc/3-star-or better/. The star rating system requires data on, for example, centre line widths, road barriers, and the proximity of hazards such as trees and poles to the edge of the road.

In order to assess the star rating, it is necessary to collect detailed data for these features on each road in a territory. It will be appreciated that this requires about 15 million of kilometres of road to be assessed, and that doing this manually is impractical and inaccurate.

Most existing approaches use image data, for example from vehicles driving the route, coupled with data analysis and a staff of humans to identify additional features. This is expensive and time consuming.

It is an object of the present invention to provide a more efficient process for extracting features from mobile LIDAR data and imagery.

### SUMMARY OF THE INVENTION

In a first broad form, the present invention provides an automated analysis method in which point cloud data is processed to partially identify features, corresponding image data is separately processed to identify related features, and the features identified in the image data are used to control the further processing of the point cloud data.

According to a first aspect, the present invention provides a method for processing image data to automatically identify a road, including at least the steps of:
a) Creating atop view image of a landscape from 360 degree imagery including a road, and data indicating the location of a camera that generated the image;
b) Detecting lines generally parallel to the expected road direction
c) Determining the x-centre of the detected lines;
d) Segmenting the image using the detected lines and x-centres into segments;
e) Classifying the segments as road, divider or other using the segment on which the camera was located as a first road segment, and using the colour data relating to the other segments to classify them as part of the road, or as other features.

According to another aspect, the present invention provides a method for converting image data to 3D point cloud data, the camera image data including a successive series of images taken at regular distance intervals from a vehicle, and in which the image data includes the azimuth angle of the vehicle position relative to the y axis of the point cloud data for each image, the method including the steps of:
a) For the i-th camera image, convert the image data to a point cloud domain to produce a first point cloud;
b) Rotate the associated cloud points by the azimuth angle of the car position;
c) Select points from the point cloud from a small predetermined distance d along y-axis in front of car location, corresponding to the distance travelled between images, to form first point cloud data;
d) For the i+1th image, repeat steps a to c to generate second point cloud data;
e) Repeat step d for a predetermined number n of images;
f) Combine the first point cloud data with the second point cloud data, displaced distance d along the y axis, and repeat for the following n images.

According to another aspect, the present invention provides a method for automatically identifying road segments from vehicle generated LiDAR point cloud data, the method including the steps of:
a) Down sampling the point cloud data to form a voxelised grid;
b) Slicing the point cloud data into small sections, corresponding to a predetermined distance along the direction of travel of the vehicle;
c) Perform primary road classification using a RANSAC based plane fitting process, so as to generate a set of road plane candidates;
d) Apply a constrained planar cuts process to the road plane candidates, to generate a set of segments;
e) Project point cloud onto the z=0 plane;
f) Identify a parent segment using a known position of the vehicle, which is presumptively on the road;
g) Calculate the width of the parent segment along the x axis, and compare to a known nominal road width;
h) If the segment is great than or equal to nominal road width, and if it is greater than a predetermined length along the y axis; then this is the road segment;
i) If not, then add adjacent segments until the condition of (h) is met, so as to define the road segment.

According to another aspect, the present invention provides a method for detecting roadside trees in point cloud data, including the steps of:
a) Filtering the point cloud data, so as to remove all data below a predetermined height above a road plane in said point cloud data;
b) Segmenting the filtered point cloud data to identify locally convex segments separated by concave borders;
c) Applying a feature extraction algorithm to the local segments, preferably viewpoint feature histogram, in order to identify the trees in the point cloud data.

According to a further aspect, the present invention provides a method for automatically detecting roadside poles in point cloud data, including the steps of:
a) Filtering the point cloud data, so as to remove all data below a predetermined height above a road plane in said point cloud data;
b) Perform Euclidian distance based clustering to identify clusters which may be poles;
c) Apply a RANSAC based algorithm to detect which of the clusters are cylindrical;
d) Filter the cylindrical candidates based on their tilt angle and radius;
e) Process a set of image data corresponding to the point cloud data, so as to identify pole objects;
f) Match the cylindrical candidates to the corresponding pole objects, so as to identify in the point cloud data.

According to another aspect, the present invention provides A method for processing vehicle generated point cloud data and corresponding image data to facilitate feature identification, wherein the image data is captured sequentially a known distance after the previous image along the direction of travel, the method including the steps of:
a) Down sampling the point cloud data to form a voxelised grid;
b) Slicing the point cloud data into small sections, each section relating to the distance along the direction of travel between the first and last of a small number of sequential images along the direction of travel of the vehicle;
c) Thereby reducing the size of the point cloud data set to be matched to the small number of images for later feature identification.

### BRIEF DESCRIPTION OF THE DRAWINGS

Various implementations of different aspects of the present invention will now be described with reference to the accompanying figures, in which:

FIG. 1 is a schematic block diagram illustrating the overall approach according to an implementation of the present invention;

FIG. 2 is flow chart illustrating the road detection process;

FIGS. 3A to 3C illustrate primary road detection;

FIGS. 4A to 4F illustrate an example of segmentation of a road section;

FIG. 5 is a flow chart of an algorithm to extract true road parts from an over-segmented point cloud;

FIGS. 6A to 6D illustrate the operation of an example according to FIG. 5;

FIGS. 7A and 7B illustrate the process of width estimation for segments;

FIG. 8 is images to illustrate the operation of an image stitching algorithm;

FIGS. 9A, 9B and 9c illustrate stages in extracting road location from imagery data;

FIGS. 10A, 10B and 10C illustrate the detection of lines features perpendicular to the x axis in imagery;

FIG. 11 shows a segmented road;

FIG. 12 illustrates the stitching together of point cloud sections;

FIG. 13 is a flow chart of an algorithm to combine the image and point cloud extracted data;

FIG. 14 is a series of images illustrating the operation of the process of FIG. 13;

FIG. 15 is an illustration of axes relative to road and vehicle position;

FIG. 16 is an overview of a process to extract true road parts from an over-segmented point cloud;

FIG. 17 illustrates a labelled set of adjacent cloud segments

FIG. 18 is a flow chart of an algorithm for a segment to segment adjacency matrix;

FIG. 19 illustrates an example of merging segments along the y-direction;

FIG. 20 is a flowchart of an algorithm to identify the road median/divider and right side of the road;

FIG. 21 illustrates the operation of condition 1 of the algorithm of FIG. 20;

FIG. 22 illustrates the operation of condition 2 of the algorithm of FIG. 20;

FIG. 23 illustrates a point cloud with vertical wall candidates from clustering;

FIG. 24 illustrates the removal of false candidates from FIG. 23;

FIG. 25 is a flowchart for an overview of pole detection;

FIG. 26 illustrates point cloud candidates for poles and a filtered output;

FIG. 27 illustrates the outcome of Euclidean distance based clustering on the filtered output of FIG. 26;

FIG. 28 shows the outcome of a RANSAC cylinder search on the data of FIG. 27;

FIG. 29 illustrates the modelling of a cylinder shaped object in 3 dimensions;

FIG. 30 shows cylinder shaped segments and a table of measurements from those cylinders;

FIG. 31 is a flowchart of a process for detecting poles from point cloud data;

FIG. 32 are images illustrating an example of the application of FIG. 31;

FIG. 33 shows images illustrating pole height calculation;

FIG. 34 illustrates some point cloud segmentations using tree detection;

FIGS. 35, 36 and 37 illustrate the efficiency of three different tree detection techniques, VFH, CVFH and ESF respectively;

FIG. 38 is a flowchart illustrating a process for identifying trees;

FIG. 39 is a flowchart illustrating the overall alternative process for Part 1 of the road detection process;

FIG. 40 is a diagram illustrating variations in surface normal;

FIGS. 41A and B are graphs showing distribution of normal components for road and false road;

FIG. 42 is an image of a noisy road candidates;

FIG. 43 illustrates the effect of Otsu thresholding on the image of FIG. 42

FIG. 44 is a series of images showing image data, point cloud, and segmentation;

FIG. 45 is a series of images illustrating the lane marking identification process;

FIGS. 46A and B show a road image and the corresponding threshold gradient;

FIG. 47A, B, C illustrate extraction and selection of road marking candidates;

FIG. 48 illustrates the changing azimuth angle of a car on a curved road;

FIG. 49 illustrates the adaptive rotation of the candidates from FIG. 47;

FIG. 50 is a flowchart illustrating the process of the lane marking detection algorithm;

FIG. 51 is an example 360 degree spherical camera image;

FIG. 52 is an example of a point cloud image in real world coordinates;

FIG. 53 the upper image is a projection of classified point cloud data, the bottom image shows projection of range data;

FIG. 54 illustrates boxes around selected left and right areas of the spherical image;

FIG. 55 is a series of camera image, projected point cloud image and at bottom the overlapping projected image on camera image;

FIG. 56 is a spherical image illustrating an error in stitching images together;

FIG. 57 illustrates the unbalanced alignment of image data with point cloud projected data;

FIG. 58 is a flowchart for a process for reference object selection; and

FIG. 59 is a flowchart of a process for alignment correction;

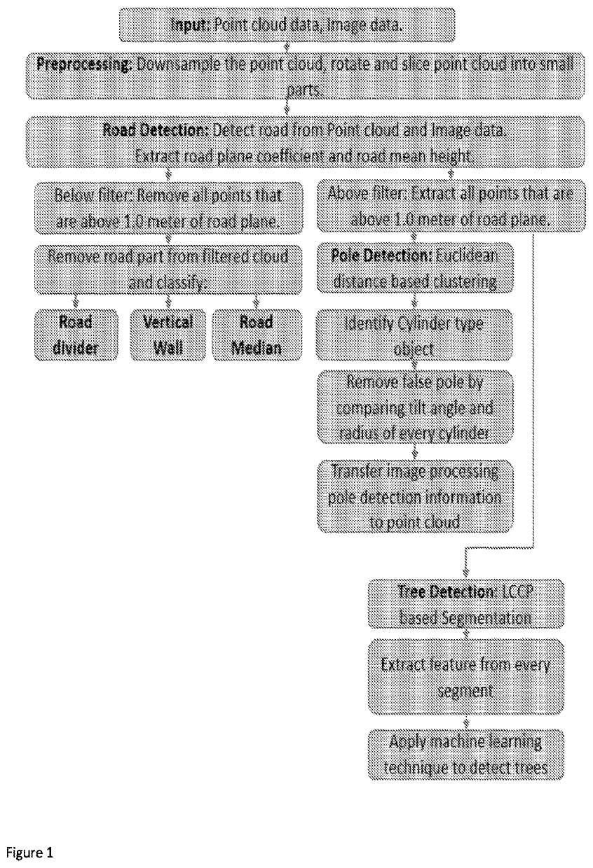

### DETAILED DESCRIPTION OF THE INVENTION

The present invention provides both an overall approach, and a series of sub-processes, for identifying a road surface and a variety of associated features. It will be understood that the various processes may be used together, or separately together with other processing steps. It will be understood that other processing steps may be used in conjunction with the illustrative examples described below.

The present invention may be carried on any suitable hardware system. In most practical situations, this will use cloud-based server resources to supply the necessary processing and memory capacity. However, the implementations described are highly computationally efficient and has been designed to run on a local system if desired.

The basic input for this implementation of the present invention is derived from a vehicle mounted sensor system. This produces a LiDAR derived point cloud data set, digital camera images taken (generally) at specified distance intervals, and the location and azimuth angle of the vehicle when the images are taken. In such a road-view mobile LiDAR system, every object of interest is located around that road. Therefore, detection of the road should be the first step of data classification.

It will be understood that while the present implementation is described in the context of a vehicle mounted system, the principles and approaches described may be applied to point cloud and image data generated in other suitable ways, for example from a flying drone, with appropriate adjustments to the assumptions and parameters. The implementation described below achieves efficient detection by combining point cloud and image data. However, point cloud data comes in a continuous large block whereas image sequence data are captured by camera at some predefined time interval. An efficient data fusion process is necessary to take advantage from both point cloud and image data.

According to the process to be described, a large block of point cloud data is sliced into some small blocks where every block is associated to a specific camera snapshot. We show that road part can be modelled as a large plane in every sliced point cloud. The observation allowed us to develop a procedure that extracts some primary road candidates from point cloud data. We then develop a framework to project the image based road detection result on point cloud.

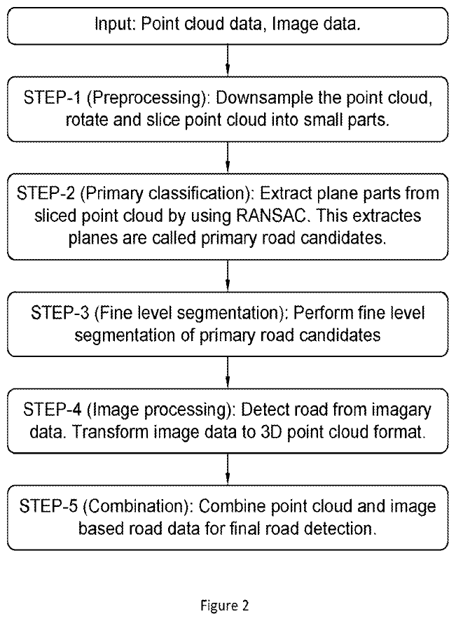

FIG. 2 provides an overview of the road detection process. The input section of point cloud data and corresponding image data is provided. This is then pre-processed, including downsampling the point cloud, rotating to align with the vehicle direction, and slicing into small parts. The data is then subject to primary classification, and then fine level segmentation. In parallel, the corresponding image data is processed to detect the road and related features, and finally the processed point cloud and image data is combined to provide final road detection.

A starting point is the following definition:

Definition 1 (y-length): Consider a point cloud segment. Every point on the cloud can be specified by a 3D vector (x; y; z). Let the maximum and minimum value of y among all points on the cloud be yₘₐₓ and yₘᵢₙ respectively. Then y length=yₘₐₓ−yₘᵢₙ

Suppose we have N GPS locations of surveillance car where camera snapshot was taken. The following process is applied for every n={1, 2, . . . N} car location independently:

STEP1.1 (Downsampling): Reduce the number of cloud points to be analysed by using a voxelized grid approach [1]. The algorithm creates a 3D voxel grid (a voxel grid can be viewed as a set of tiny 3D boxes in space) over the input point cloud data. Then, in each voxel, all the points present will be approximated (i.e., downsampled) with their centroid or other methods used to represent a block of data.

STEP1.2 (Rotate and slice point cloud into small parts): Point cloud data comes in a continuous large block. The point cloud data is combined with imagery data for better classification. However, a continuous imagery dataset is not available. In general, the vehicle mounted system takes camera snapshots after some predefined distance intervals. Let the distance between two camera snapshots be L metres. The imagery datasets also store the current location and azimuth angle of surveillance car when a camera snapshot is taken. For every given camera snapshot location we rotate the point cloud around the z-axis so that azimuth angle of the point cloud is aligned with car azimuth angle. The rotation generally aligns road in y-axis direction. Then slice the point cloud up to 4 L metre in the y-direction, starting from the correct vehicle position.

For clarity, we note that the z-axis is vertical, the y-axis (once aligned) is parallel to the road axis and the direction of travel of the vehicle; and the x-axis is perpendicular to the direction of travel. These orientations are used throughout the description and claims, unless a contrary intention is expressed.

The next step (Step-2 in FIG. 2) is primary classification. The basic observation from point cloud data is that road part creates (one or multiple) large plane surfaces in the point cloud. However, note that plane surfaces may contain other objects such as footpaths, terrain etc. We shall remove these in the next step. Let P be an empty point cloud. The basic steps of primary classification are as follows:

Step-2.1: Set a threshold value aₜₕ. Apply RANSAC based plane fitting [1] (see below) repetitively on the point cloud data to extract multiple plane surfaces. For every iteration, RANSAC extracts a part of point cloud and its associated plane coefficient. If the extracted point cloud size is larger than aₜₕ then merge the extracted cloud with P.

Step-2.2: RANSAC based plane fitting gives plane coefficient (a; b; c; d) for every fitted plane such that for any point (x; y; z) in 3D coordinates the plane is defined as

ax+by+cz+d=0: (1.1).

The plane coefficient associated to the largest extracted point cloud will be defined as the road plane coefficients.

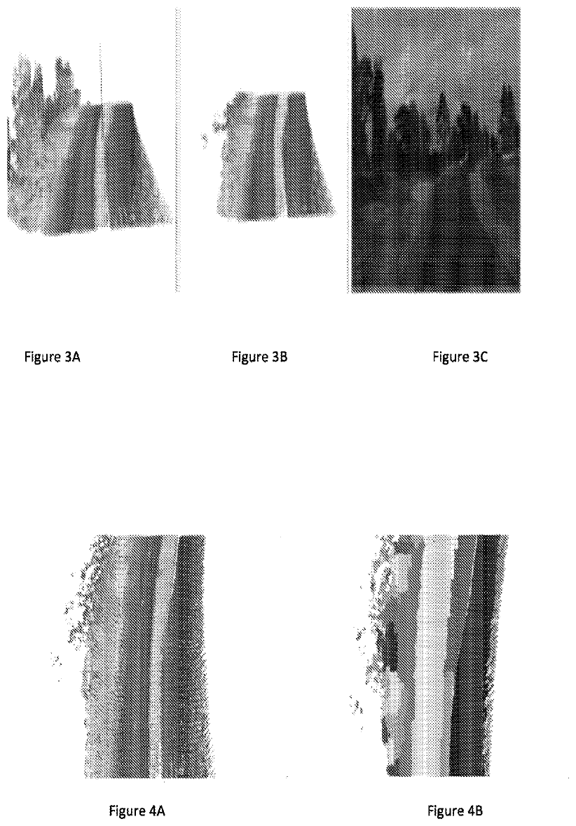

FIGS. 3A to 3C illustrate an example of this process. FIG. 3A illustrates the input point cloud; FIG. 2 is the primary road as extracted by RANSAC; and FIG. 3 is the image view of the input cloud location. We see that Primary road contains the true road part, however, it also includes roadside terrain.

The RANdom SAmple Consensus (RANSAC) algorithm proposed by Fischler and Bolles [14] is a resampling technique that generates candidate solutions by using the minimum number observations (data points) required to estimate the underlying model parameters. Unlike conventional sampling techniques such as M-estimators and least-median squares (see reference [16] that use as much of the data as possible to obtain an initial solution and then proceed to prune outliers, RANSAC uses the smallest set possible and proceeds to enlarge this set with consistent data points (see reference [4]).

The RANSAC algorithm can be used for plane parameter estimation from a set of 3D data points. A plane in 3D space is determined by a point (x, y, z) and four parameters {a, b, c, d}:

ax+by+cz+d=0 (1.2)

By dividing both side of (1) with c, we get:

âx+\hat{b}y+\hat{d}=−z, (1.3)

where

$$\hat{a} = \frac{a}{c} , \hat{b} = \frac{b}{c} and \hat{d} = \frac{d}{c .}$$

Given a point (x, y, z), the plane equation has 3 unknowns. Therefore, we need 3 different points to estimate plane parameters. Suppose three different points are

{(x₁,y₁,z₁),(x₂,y₂,z₂),(x₃,y₃,z₃)}

then we always construct a plane that passes through the points where the plane parameters {â, \hat{b}, ĉ} can be estimated by solving the following system of equations:

$$[ \begin{matrix}{x}_{1} & {y}_{1} & 1 \\ {x}_{2} & {y}_{2} & 1 \\ {x}_{3} & {y}_{3} & 1\end{matrix} ] [ \begin{matrix}\hat{a} \\ \hat{b} \\ \hat{c}\end{matrix} ] = - [ \begin{matrix}{\hat{z}}_{1} \\ {\hat{z}}_{2} \\ {\hat{z}}_{3}\end{matrix} ] \qquad ( 1.4 )$$

Now suppose we have N data points in 3D coordinates and we want to fit a plane model by using RANSAC. The algorithm is described below:
Input: N data points in 3D coordinates. The set of all data points is denoted by P. Set an inlier threshold value τ and number of iterations T.
Initialize: Let M be an empty set. Define Cₘₐₓ=0.
Loop-1: For i=1 to T, do the following:
   Step-1: Select 3 data points randomly from P with uniform probability.
   Step-2: Estimate {â, \hat{b}, ĉ} by solving (1.4).
   Step-3: Set s=0.
   Loop-2: For k=1 to N do the following:
      Step-3.1 Let the k-th point from [symbol] is (xₖ, yₖ, zₖ). Calculate d=∥âxₖ+\hat{b}yₖ+\hat{d}+zₖ∥₂ where ∥·∥₂ denotes L2-norm
      Step-3.2 if d<τ then s=s+1
   End Loop-2
   Step-4: if s>Cₘₐₓ then
      Step-4.1: M={â, \hat{b}, ĉ} and set Cₘₐₓ=s.
End Loop-1
Output: The plane model parameters M.

The identified Primary road segment contains true road as well as some false objects. We need to remove this. At a first step we perform a fine level segmentation. For this we apply an algorithm called Constrained planar cuts (CPC) [2]. The algorithm performs partitioning of a supervoxel graph. In particular, it uses planar cuts induced by local concavities for the recursive segmentation. Cuts are estimated using locally constrained directed RANSAC.

The goal of CPC is to partition point clouds into their constituent objects and object parts without any training. Given a point cloud dataset, the algorithm works using the following steps.

### Local Concavity Evidence Extraction

First, create a surface patch adjacency graph which over-segments a 3D point cloud into an adjacency graph of supervoxels. Voxel Cloud Connectivity Segmentation (VCCS) algorithm (see reference [17]) is used to compute the supervoxels. VCCS uses a local region growing variant of k-means clustering to generate individual supervoxels. For every supervoxel, it also calculates centroid pᵢ=[xᵢ, yᵢ, zᵢ]^{T}, normal vector nᵢ, and set of edges to adjacent supervoxels Nᵢ. We then measure convexity of every edge and label them as either convex or concave. Suppose the edge eᵢ is separating supervoxels j and k. Then the edge is labelled as convex if

nⱼ^{T}dᵢ−nₖ^{T}dᵢ≥0,
where,

$${d}_{i} = \frac{{p}_{j} - {p}_{k}}{{‖ {p}_{j} - {p}_{k} ‖}_{2}} \qquad ( 1.5 )$$

### Euclidean Edge Cloud

Next, convert the adjacency graph into a Euclidean Edge Cloud (EEC), where points are generated from edges in the adjacency graph. Suppose we want to convert the edge eᵢ to point. The edge separates the supervoxels j and k with centroid pⱼ and pₖ respectively. The point-coordinate for the edge in EEC is set to the average of the pⱼ and pₖ. Additionally, the points stores the direction of the edge d (see eq. (1.5) together with the angle α between the normals of both supervoxels j and k. The angle is measured by using the following equations:

α=cos⁻¹(nⱼ^{T}nₖ) (1.6)

### Geometrically Constrained Partitioning

Use the EEC to search for possible cuts using a geometrically-constrained partitioning model. To find the planes for cutting, a locally constrained and directionally weighted sample consensus algorithm (called weighted RANSAC) is applied on the edge cloud. Weighted RANSAC applies similar steps as described above, additionally it allows each point to have a weight. Points with high positive weights encourage RANSAC to include them in the model, whereas points with low weights will penalize a model containing them. All points are used for model scoring, while only points with weights greater than zero are used for model estimation. To be more clear, consider Step-1 in [0070] above, where we select 3 points randomly with uniform probability from N in [symbol] data points, i.e., the selection probability of every point is 1/N. Now consider that points are weighted with wᵢ for i=1, 2, . . . N such that Σᵢ₌₁^{N}wᵢ=1. In the weighted RANSAC, the selection probability of the k-th point is wₖ.

The weight of the i-th point is calculated as:

w̅ᵢ= [symbol] (α−βₜₕ) (1.7)

where βₜₕ=10 and [symbol] (x) is a heaviside step function defined as

$$ℋ ( x ) = \{ \begin{matrix}0 , if x < 0 \\ 0.5 , if x = 0 \\ 1 , if x > 0\end{matrix} \qquad ( 1.8 )$$

Simply weighting the points by their angle is not sufficient. Therefore, directional weighting is also used. Let sⱼₖ denote the vector perpendicular to the surface model constructed by supervoxel j and k and dᵢ is the i-th edge direction calculated from equation 1.5. The new weight is calculated as

wᵢ=w̅ᵢtᵢ (1.9)
where,

$${t}_{i} = \{ \begin{matrix}{d}_{i}^{T} {s}_{jk} , & if i - th edge is concave \\ 1 , & otherwise\end{matrix} \qquad ( 1.1 )$$

The weighted RANSAC algorithm is applied multiple times to generate multiple planes. Finally, the input point cloud is segmented along the plane surfaces.

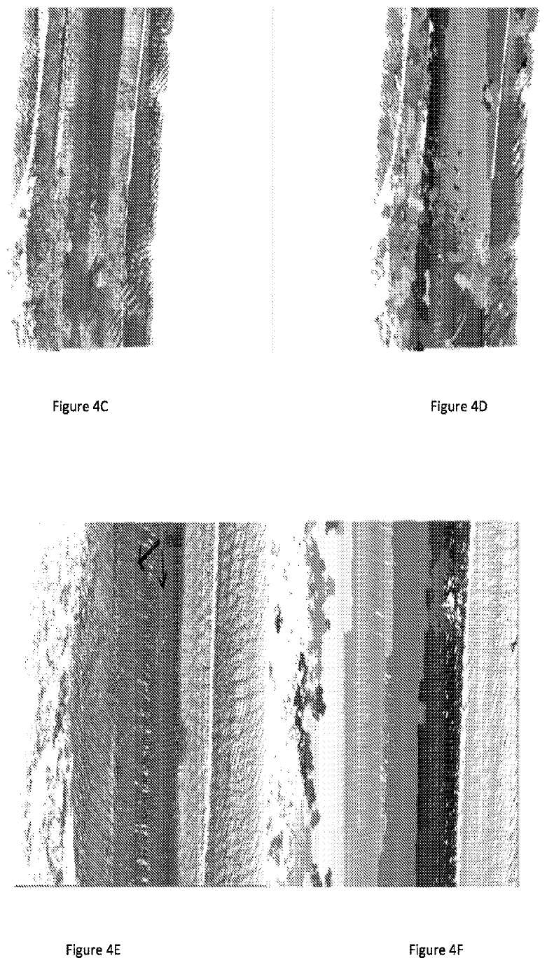

FIGS. 4A and 4B illustrate an example of CPC segmentation. We see that road is fragmented into a large segment. The next task is to identify the road segment. However, CPC cannot always segment the road perfectly.

CPC segmentation does not always give the desired result due to noisy point cloud data, noisy intensity variation, and other issues. In FIG. 4C, the source point cloud is very noisy. Therefore the bottom road part after CPC segmentation in FIG. 4D is fragmented into many parts. We cannot identify the road segment properly. FIG. 4E shows another example. Here, the source point cloud has a regular intensity variation pattern along the centre of the road. Therefore, CPC split the road into two parts, as can be seen in FIG. 4F.

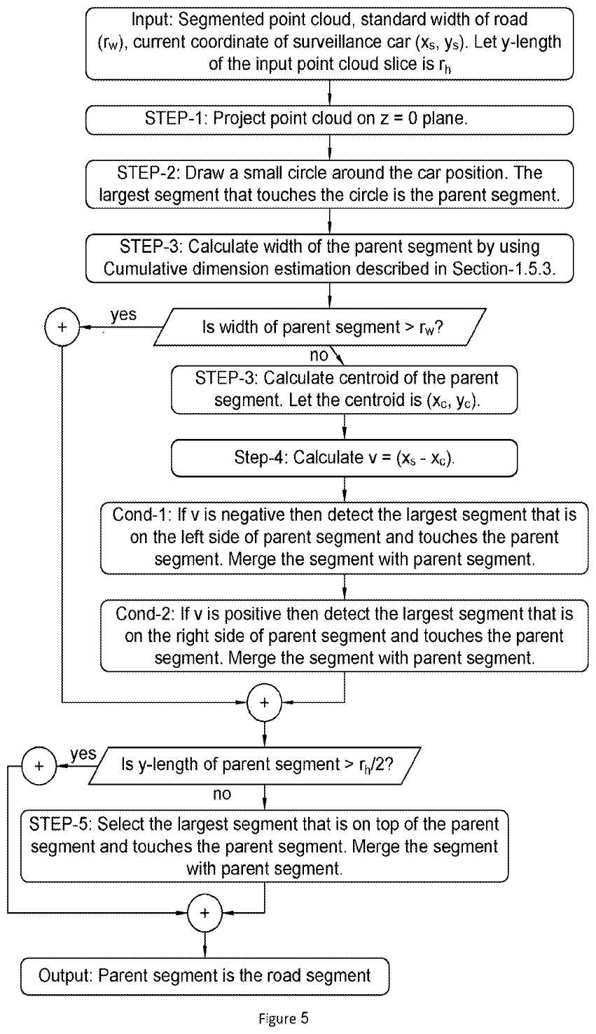

We observe that the CPC algorithm cannot always give perfect road segmentation. Therefore, we apply an algorithm to extract true road parts from an over-segmented point cloud. The flowchart of the algorithm is shown in FIG. 5.

The CPC based point cloud segmentation is used as input to the algorithm. As described above, we know the vehicle position from the image dataset. The car must be on the road. In Step-2 of this algorithm, we draw a small circle around the car position. The largest segment that touches the circle is the parent of the road segment. However, full road can be fragmented into many small parts (see FIG. 4C to 4F).

To identify whether the parent segment is complete road or not, we use the standard road width (r_{w}) information. This is a known nominal value for a particular road system. If the width of the parent segment is smaller than r_{w} then we search fragmented parts in some expected direction to complete the full road segment (Step-3 to Cond-2).

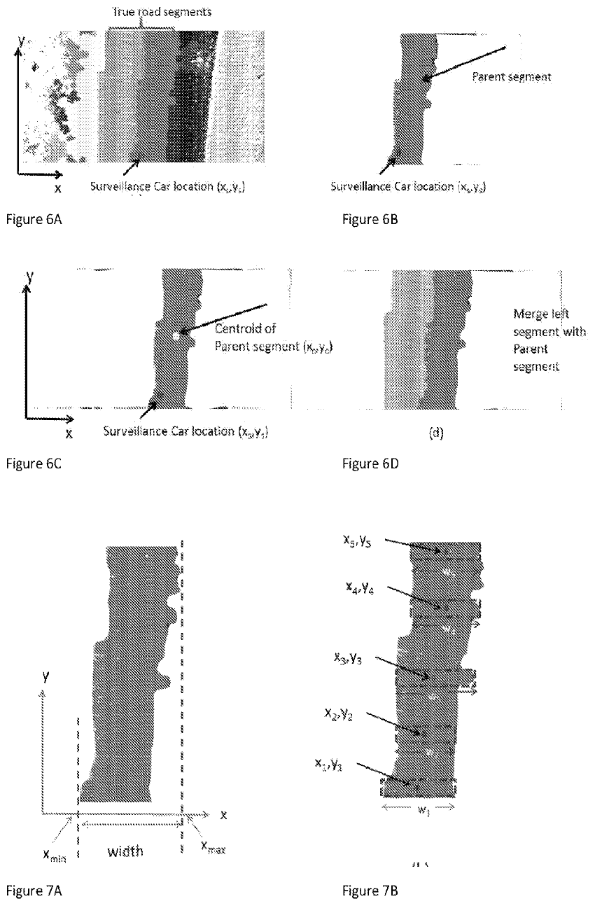

The procedure is demonstrated with an example in FIG. 6A to 6D. FIG. 6A shows the CPC segmentation of a point cloud. The surveillance car location is marked with red circle. In Step-2 of the algorithm we select the segment where car location overlapped. FIG. 6B shows the selected parent segment. The width of the parent segment is smaller than standard road width.

It is noted that width detection of the fragmented segment is not straight forward. We develop a Cumulative dimension estimation procedure in the following section.

In Step-3, the centroid of the parent segment is calculated. FIG. 6C shows the centroid with a yellow circle. We see that (xₛ−x_{c}) is negative. Therefore, Cond-1 is satisfied and left side segment of parent segment is merged to create the final road segment. This algorithm works well for a moderate level of point cloud noise. However, if point cloud is very noisy then it cannot give the desired result. To get a more accurate result, we need to combine the point cloud data with image classification data.

As noted above, estimation of the width of a segment is not always simple. Consider the 2-D segment image as shown in FIG. 7A. We want to estimate its width and central contour. The basic procedure of width calculation is w=xₘₐₓ−xₘᵢₙ, where xₘₐₓ and xₘᵢₙ are the maximum and minimum x-axis bounds of the segment. This process gives a good estimation if the segment surface is smooth and if the segment is aligned to the y-axis direction. Otherwise, it gives a larger width than the actual value. We use an alternative procedure to correct the estimation error. We fragment the segment into N small segments along the x-direction, as shown in FIG. 7B. We compute width for every segment separately. The final width value is:

$$; {w}_{c} = \frac{1}{N} {{\sum }_{n = 1}}^{N} {w}_{n}$$

For every fragmented segment we calculate its centroid (xₙ, yₙ). The set of all centroids will be called the central contour, i.e., q=[(x₁, y₁); (x₂, y₂); . . . (x_{N}; y_{N})]. FIG. 7B shows an example where segment is fragmented into 5 small segments.

Road Detection from Images

Image processing is required to extract the road components from the 360° panoramic images. One guiding principle is that the vehicle should be on the left side of road (or right hand side, depending on local rules).

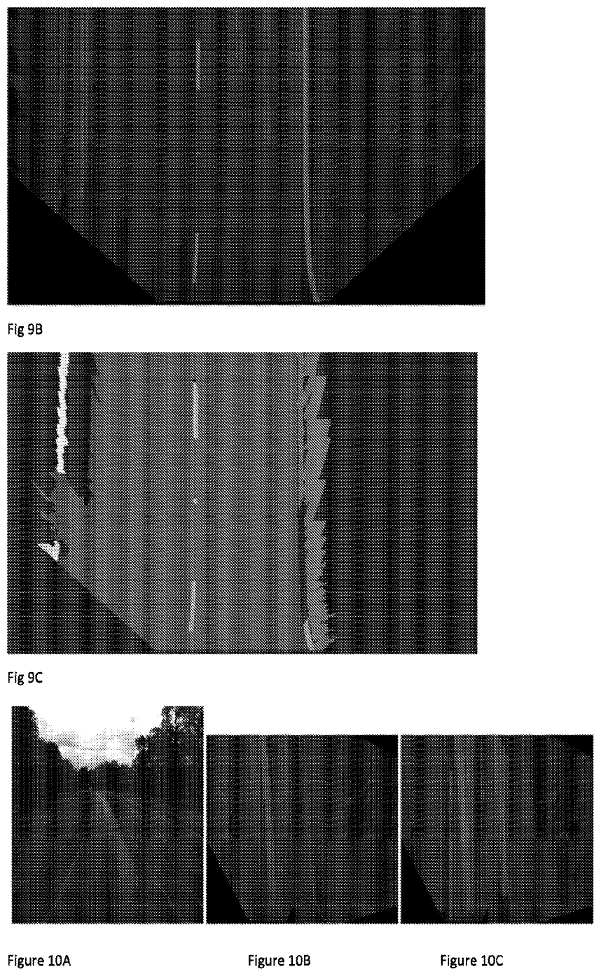

If we generate a top view of the road, then the road boundary texture or boundary median line generates a set of straight lines that are generally perpendicular to the x-axis. In some cases, the lines are not perpendicular, and as described below a machine learning algorithm is trained to adapt to this. This can be seen from FIGS. 9A, 9B and 9C. FIG. 9A shows the true image; 9B the view transformed to a top view; and 9C the connected components. The steps of the approach according to this implementation are as follows:

Step 1: Detect group of vertical lines from top view of image by using either Hough transform or Deep Learning (e.g., Fast-RCNN). FIG. 10A shows the true image; 10B the top view: 10C the group of vertical lines detected.

In general, road markings create lines on the road image. There are various standard algorithms such as Hough Transform which can be used to detect these lines. However using the fact that in the top-view image (see FIG. 9B, 9C), most of the road feature markings are almost vertical to x-axis, this paper makes use of Faster-RCNN (Region with Convolutional Neural Networks) [18] as a line detection tool. It outputs bounding boxes of different line objects detected and classifies the lines into different categories namely median line, road boundary, center-line, and turning markings. In this case, the task of classifying the detected line is further simplified by the use of Faster-RCNN, whereas when using standard line detection algorithm like Hough Transform, it has to be followed with another classification algorithm for line classification. Furthermore, Faster-RCNN is also extremely fast in GPU, and therefore it is preferred that this algorithm applies Faster-RCCN for road marking and boundary detection and classification.

Step 2: Collect x-centre of every group of vertical lines. Given the set of x-centre points, perform Euclidean distance based partitioning by using the K-means algorithm [10]. The function returns x-centres of every cluster classes.

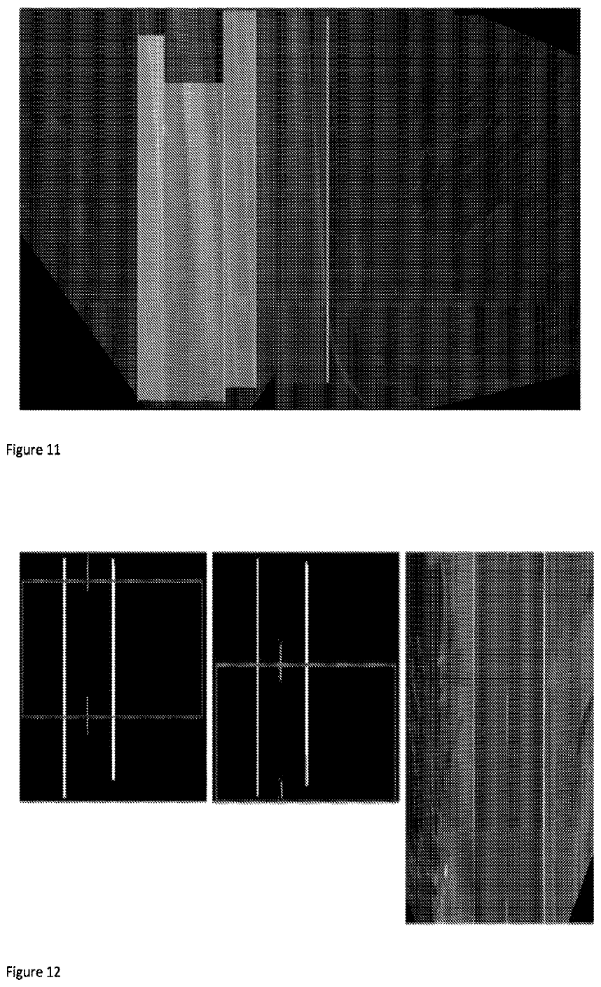

Step-3: Given the partition x-centres and associated vertical lines group perform segmentation of the input image. FIG. 11 illustrates the segmented road from this step.

The next process is to classify the segmented parts of road: As we see in FIG. 11, not all identified segments are road. Some segments may be terrain, road divider, etc. The steps of this classification process are as follows:

Step-1 (Source road). We know current location of the vehicle. The segment that belongs to the vehicle is called source road.

Step-2: We observe that at a given camera snapshot:
The RGB colour of all road segments is matched closely to the source road.
The RGB colour of divider is significantly different from source road.
The Hue and Saturation value of terrain and vegetation is significantly different from the source road.

It is important to note that these observations are true if we compare colours of single image snapshots. More clearly, suppose the image snapshot Pᵢ is taken at midday and Pⱼ is taken at evening. Let Sᵢ, Rᵢ, Tᵢ denotes the source road segment, right lane of road and terrain respectively for the image Pᵢ. Similarly, Sⱼ, Rⱼ, Tⱼ are for image Pⱼ. Then Step 2 states that the colour of Sᵢ and Rᵢ are similar, and colour of Sᵢ and Tᵢ are different. The same statement is true if we compare colour of Sⱼ and Rⱼ. However, if we compare the colour of Sᵢ and Rⱼ, then they should be different.
Step-3: For a given segment index l let h_{l,r} denotes an n-dimensional vector which is generated from red color histogram. Similarly generate h_{l,g}, h_{l,b}, h_{l,h}, h_{l,s} for green, blue, hue and saturation respectively.
Step-4: Let h_{s,r} denotes the red color histogram vector of source road segment. For a given segment lₗ, compute a 5×1 vector dₗ, where the first component of dₗ is Chi-Square distance of red color histograms, i.e.,

$$\text{?} ( 1 ) = {{\sum }_{i = 1}}^{n} \frac{{( {h}_{s , r} ( i ) - \text{?} ( i ) )}^{2}}{{h}_{s , r} ( i )} \qquad ( 1 )$$

$$\text{?} \text{indicates text missing or illegible when filed}$$

Similarly generate dₗ(2) . . . dₗ(5) for green, blue, hue and saturation respectively.

Step-5: By using the Chi-Square distance vector dₗ and width of the segment as feature vector, we train a random forest decision tree to separate road and non-road.

A Random Forest is a supervised learning algorithm. The forest it builds is a collection of decision trees [12], [13]. A decision tree is a binary classifier tree where each non-leaf node has two child nodes. More generally, a random forest builds multiple decision trees and merges them together to get a more accurate and stable prediction.

Given a training dataset, the decision tree is built on the entire dataset, using all the features of interest to train itself, whereas a random forest randomly selects observations and specific features from the dataset to build multiple decision trees from and then averages the results. After training, the classification in random forest works as follows: the random trees classifier takes the input feature vector, classifies it with every tree in the forest, and outputs the class label that received the majority of “votes”.

To train a random forest, we need to select the number of decision trees and depth of every tree. The number of tress and depth are determined by the specific requirements of the data, computational complexity and other factors. For the purposes of the present implementation of the invention, a suitable random forest may be to select 100 trees with the depth of every tree as 10.

Suppose we want to train a random forest which is composed of m trees. We need some training features of the object to classify. Suppose we have n training feature vectors. The training dataset is composed with both true and false samples. Every training vector is associated with a scalar value called label. For example, if we want to train road, then the training features that come from road will be labelled as 1 and non-road features will be labelled as 0. Denote the training feature set by D. Random forest is trained iteratively by using ‘bagging’ method. Bagging generates m new training sets { [symbol] ᵢ}_{i=1′}^{m}, each of size i, by sampling from D uniformly and with replacement. By sampling with replacement, some observations (feature vector) may be repeated in each { [symbol] ᵢ}ᵢ₌₁^{m}. This kind of sample is known as a bootstrap sample. Now feed Dᵢ to the i-th tree as input. The tree is trained using an linear regression model fitting approach (see reference [19] for more detail).

### Mapping Image Data to Point Cloud Data

In order to combine the image data with the point cloud data, it is necessary to ensure that the image sequences can be correctly mapped to the cloud domain. For a given camera snapshot, if we want to convert the image data to point cloud then we need the following information:
The location of the camera in world coordinate system.
The camera projection matrix. We can use this matrix to project image point to 3-D world points.

However, we have a sequence of image data in which successive camera snapshots are taken after some small distance interval. If we transfer every image to the point cloud then points of two successive images will overlap significantly. It is necessary to stitch the image sequences efficiently to produce the final point cloud.

As part of the input for image stitching, for every camera snapshot, the car azimuth angle is known. The camera images for this example are 360° panoramic images, and we work with the part of image which is in front of the car location.

Assumption I: The car travelled distance between successive camera snapshot is small. In this implementation, distances less than 15 metre are sufficiently small. It will be appreciated that different distances may be applicable in other applications.

Principle I: For i-th camera snapshot, convert image data to the point cloud domain. Rotate the associated cloud points by the azimuth angle of car position. Select cloud points from a small distance d (along y-axis) in front of car location. Denote the set of points by Pᵢ. If the azimuth angle difference of two successive camera snapshots is small then under Assumption I, Pᵢ₊₁ should be in the forward direction along y-axis from Pᵢ.

If we can stitch Pᵢ and Pᵢ₊₁ properly then they should approximately be a straight road. In this example, d is taken 30˜40 metre for azimuth angle difference less than 5°. We explain the principle in the following section.

Let us consider the i-th and +1-th camera snapshot, their associated camera locations in the real world coordinate system are:

(\hat{x}ᵢ,ŷᵢ,zᵢ) and (\hat{x}ᵢ₊₁,ŷᵢ₊₁,zᵢ₊₁)

and car azimuth angles are θᵢ and θᵢ₊₁ respectively. Rotate the coordinates by their associated car azimuth angles. Let the rotated coordinate be (xᵢ; yᵢ; zᵢ) and (xᵢ₊₁; yᵢ₊₁; zᵢ₊₁) respectively. The point cloud generated from i-th and i+i-th camera image in rotated coordinate system are Pᵢ and Pᵢ₊₁ respectively. By Principle I, yᵢ₊₁>yᵢ. Let Pᵢ(y_{q}: yᵣ) denote the point cloud which is extracted from Pᵢ by retaining points with y value in [y_{q}, yᵣ]. Now if θᵢ=θᵢ₊₁, then for some yᵣ>yᵢ₊₁ we can say that Pᵢ(yᵢ₊₁: yᵣ) are a replica of Pᵢ₊₁(yᵢ₊₁: yᵣ).

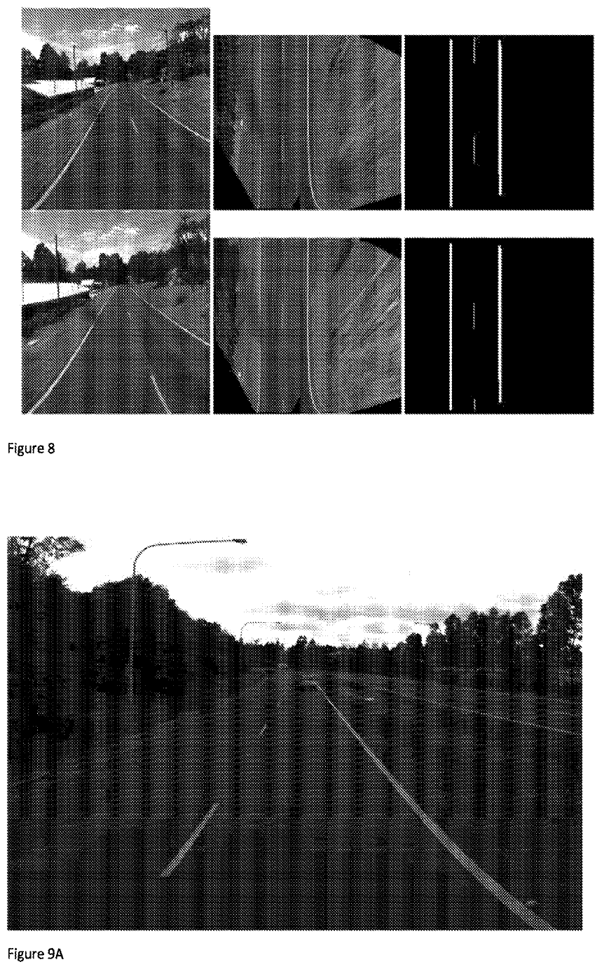

However, we generate P from camera image data. The 360° panorama camera image has the limitation that points closer to the camera are deformed more compared to points further from the camera. For example, see the middle images in FIG. 8. Therefore, the information in Pᵢ(yᵢ₊₁: yᵣ) is more accurate than Pᵢ₊₁(yᵢ₊₁: yᵣ). We should stitch Pᵢ(yᵢ₊₁: yᵣ) with Pᵢ₊₁(yᵢ₊₁: yᵣ) to create a good point cloud where d>yᵣ−yᵢ.

We can perfectly stitch Pi+1 with Pi if

(\hat{x}ᵢ, ŷᵢ, zᵢ) and (\hat{x}ᵢ₊₁, ŷᵢ₊₁, zᵢ₊₁) are the correct camera locations at the time of camera snapshot, and θᵢ and θ_{i+1,} are correct car azimuth angles.

In practice we never know the above information accurately. Therefore, we propose a template matching procedure which can stitch point clouds generated from successive camera snapshots efficiently. Note that this procedure is not required if the azimuth angle is greater than 5°. Given i-th and i+1-th camera snapshots and values yᵣ; yₛ such that yₛ>yᵣ>yᵢ₊₁>yᵢ the procedure is described as follows:

Step 1: Convert top-view of the i-th camera image.

Step 2: Perform road segmentation by using the procedure described around FIG. 11. Construct a binary mask Mⱼ by using the vertical road segment boundaries.

Step 3: Detect the road centreline marking, if exists. Add the centrelines to the mask Mᵢ. FIG. 8 illustrates an example. The top row is the ith camera shots, and the bottom row is the (I+1)-th camera shot. Left is the true image; middle is top view; and right is the generated mask of road boundaries and centre line.

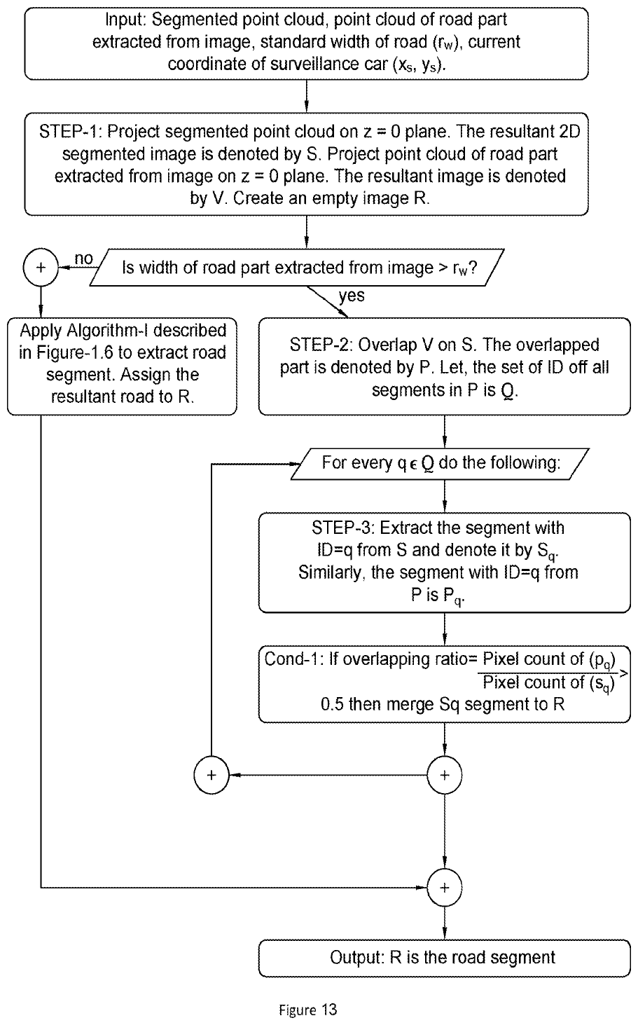

Step 4: Select the part of template Mᵢ whose associated cloud point is Pᵢ(yᵢ₊₁: yᵣ). The selected template is denoted by M_{iy}_{ᵣ}. See FIG. 12, left image.

Step-5: Repeat Step-1 to Step-3, for i+1th camera snapshot. Let M_{i+1 y}_{ᵣ} denotes the selected template which is associated to the point cloud Pᵢ₊₁(yᵢ₊₁: yᵣ).

Step-6: Apply the template matching algorithm [11], where M_{i+1 y}_{ᵣ} is the source image and M_{i y}_{ᵣ} is the template image. The algorithm will give shifting parameter (x, y). Shift Pᵢ(yᵢ₊₁:yᵣ) by using (x,y) and stitch it with Pᵢ₊₁(yᵣ: yₛ). This is illustrated in FIG. 12, in which the left image is the selected part of the ith image, and the right is the selected part of the (i+1)-th template.

The final algorithm, to combine the point cloud and image date, is described in FIG. 13. In Step-1, we create 2-D images of CPC segmented point cloud and road cloud extracted from image by projecting the clouds on z=0 plane. The images are denoted by S and V respectively. If the width of the image based road cloud is smaller than the standard road width then we do not use the image data for road detection. Instead, apply Algorithm-I described in FIG. 5. However, if we get a standard size road from the image data, then apply the combination process. Step-2 creates the image P by overlapping V on S. In Cond-1, we check the possibility of every segment in P to be part of road or not.

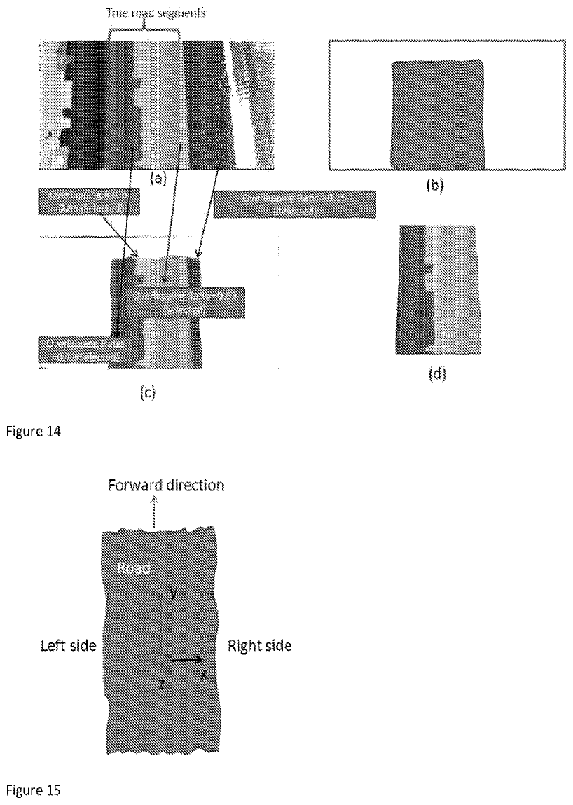

FIG. 14 shows an example of this combined algorithm for road detection. FIG. 14(a) shows a segmented point cloud image S. FIG. 14(b) shows road classified cloud image V generated from image data. In Step-3 of the algorithm we overlap V and S and create overlapped image P which is shown in FIG. 14(c).

For every overlapped segment of P, we calculate the overlapping ratio. If overlapping ratio is greater than 0.5 (cond1) then select the source segment as road segment, and the source segment is merged with output road image R. FIG. 14(c) shows the overlapping ratio of different segments. Finally, FIG. 14(d) shows the output.

### Detecting Road Dividers, Vertical Walls and Median

The next section is concerned with taking the segmented point cloud data with the road part detected, and extracting vertical walls, road dividers, the road left and right, and the median strip.

We describe below an algorithm that extracts the relation between different segments of a segmented 3D point cloud. Note that extracting segment-to-segment relations in 2D data (like image) is not very difficult. However, this is not trivial in 3D point cloud data. There is further a procedure that separates left and right side and median of the road. The algorithm can also identify road divider of a two-way road. There is further disclosed a procedure and a set of decision making hypothesis that identify vertical walls from point cloud data.

The first stage is preprocessing, with the following steps:

Step 1: Separate plane parts from a point cloud slice by applying RANSAC. Then perform fine segmentation by using an algorithm, for example Constrained Planar Cuts (CPC) [2], and perform road classification by using the process described above. This uses, for example, the RANSAC algorithm described at [0070] above and following.

Step 2: Rotate the point cloud around the z-axis so that azimuth angle of the point cloud is aligned with the sensor vehicle azimuth angle, i.e., the road forward direction is aligned with the positive y-axis direction. Hence, if we shift the origin of coordinate system to the centre of the road then positive and negative x-direction will be right side and left side of the road respectively. This is illustrated in FIG. 15.

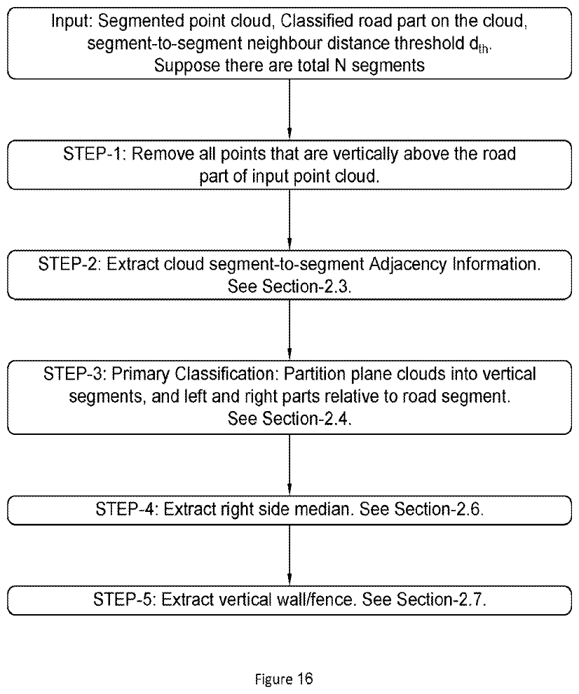

FIG. 16 provides an overview of the process to extract true road parts from an over-segmented point cloud. It will be appreciated that although it is preferred that the starting point is the point cloud data from the road classification system described in detail above, this aspect of the present invention can be implemented using any set of point cloud data with the road already detected.

Definition 2 (Neighbour points): Let P1: (x1; y1; z1) and P2: (x2; y2; z2) be two points on two different cloud segments. Given a threshold distance (dₜₕ), the point-pair will be neighbours to each other if the Euclidean distance between the points is smaller than dₜₕ.

Definition 3 (Relative Point direction): Suppose P1: (x1; y1; z1) and P2: (x2; y2; z2) be two points on two different cloud segments. Then direction of P2 with respect to P1 is computed as

P_{dir}=(s(x₁,x₂),s(y₁,y₂),s(z₁,z₂))
where

$$s ( {x}_{1} , {x}_{2} ) = \{ \begin{matrix}1 & {x}_{2} \geq {x}_{1} \\ - 1 & {x}_{2} < {x}_{1}\end{matrix} \qquad ( 2.1 )$$

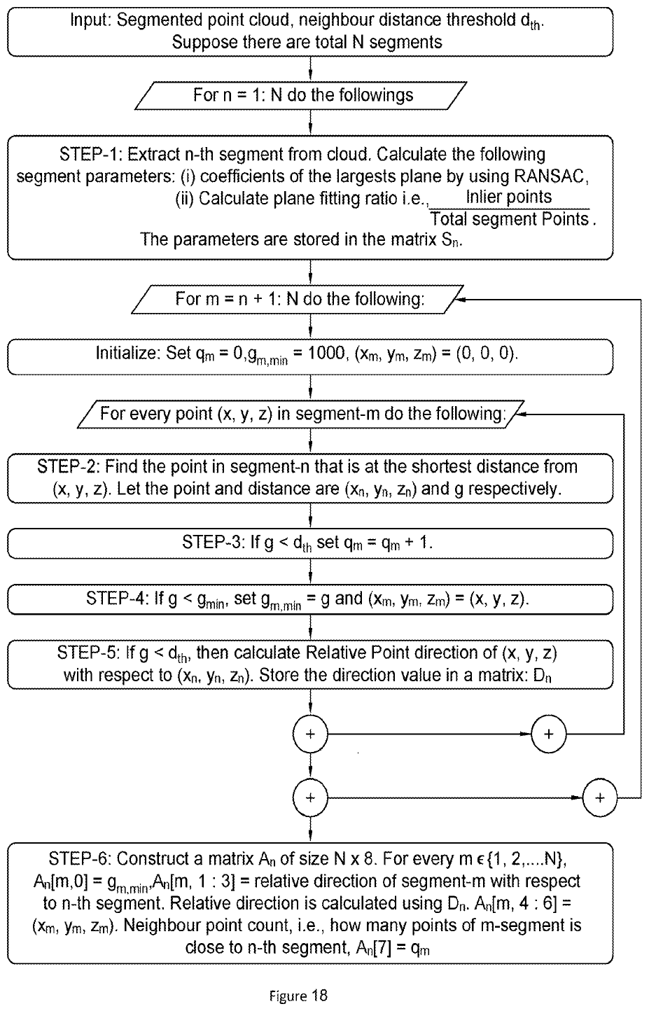

The algorithm for the segment to segment adjacency matrix is illustrated in FIG. 18. Suppose the input segmented point cloud has N segments. For every segment n∈{1, 2, . . . N} the algorithm computes the following information:

a. Plane parameters: It applies a RANSAC plane fitting algorithm on the segment and extracts the plane coefficients.
b. Plane fitting ratio: Suppose there are M points in segment n, and RANSAC can fit the largest plane by using Mᵣ points (inlier) then:

$$Plane fitting ratio = \frac{{M}_{r}}{M} .$$

The plane fitting ratio indicates how accurately a plane model is fitted on the data of given segment. A small value of the ratio indicates the low probability of a plane on the cloud data.

The algorithm also computes the following relative information of the n-th segment with other existing segments m∈{1, 2, . . . N}, m≠n.

a. The shortest point distance gₘᵢₙ between n-th and m-th cloud segment. Suppose the set of all points on n-th segment and m-th segment are N and M respectively. Shortest point distance gₘᵢₙ is measured as

$${y}_{min} = \text{?} \sqrt{{( {x}_{n} - {x}_{m} )}^{2} + {( {y}_{n} - {y}_{m} )}^{2} + {( {y}_{n} - {y}_{m} )}^{2}} . \qquad ( 2.2 )$$

$$\text{?} \text{indicates text missing or illegible when filed}$$

b. Identify if m-th segment is neighbour to n-th segment. In particular, a neighbour indicator flag will be turned on if gₘᵢₙ<dₜₕ, where dₜₕ is a predefined neighbour distance threshold.
c. Neighbour point count computes the number of neighbour point-pairs (see Definition-2) between m-th segment and n-th segment.
d. Relative position of m-th segment with respect to n-th segment.

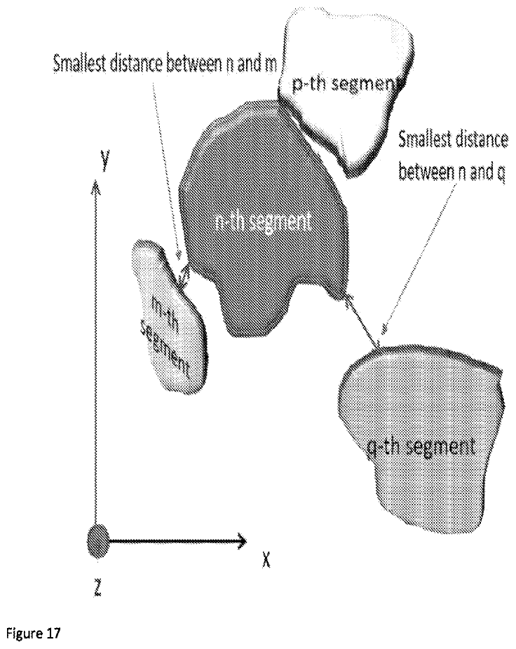

FIG. 17 shows an example of labelled cloud. Suppose we set dₜₕ=0.2. Then p-th segment cloud is neighbour to the n-th segment cloud, because the shortest point distance between the two clouds is smaller than dₜₕ. The relative position of p-th segment with respect to n-th segment is (1; 1; 1). This implies that p-th segment is located at right side (positive x direction) and on top y-direction with respect to n-th segment. Similarly the relative position of q-th segment is (1; −1; −1).

### Identify Vertical Walls

The next stage is to perform primary classification, so the point cloud is partitioned into vertical segments, and left and right parts relative to the road segment.

a. Vertical segment: A segment will be identified as vertical segment if its elevation angle is above 60° and Plane fitting ratio >0.5. The elevation angle and plane fitting ratio can be obtained from cloud segment-to-segment information.

b. Left and right segments relative to road segment: A segment will be identified at left of road if its x-direction with respect to road segment is negative. We use Cloud Segment-to-Segment Adjacency Information for this classification. For example, suppose n-th segment in FIG. 17 is a road segment. Then m-th segment is on the left side; p-th and q-th segment are on the right side. For every left or right segment the following information are also collected:
Is the segment neighbour to the road segment? This data is readily available in the Cloud Segment to-Segment Adjacency Information matrix. In FIG. 17, p-th segment touches the road and q-th segment not.
Size of the segment.

The next step is to merge the cloud segments along the y-direction. Suppose we have an input segmented cloud. Given a parent segment, we search segments from the input cloud so that by merging them with the parent, it will increase the dimension of the resultant segment along y-direction while approximately preserving the mean width of parent segment.

### Merging Segments to Parent Segment

The input is a segmented point cloud and parent segment.

Step1: Calculate xₘᵢₙ; xₘₐₓ and width of parent segment by using the Cumulative dimension estimation algorithm (see above).

$$Set {x}_{right} = \frac{segment width}{5} and {x}_{left} = \frac{- segment width}{5} .$$

For: every segment (say m-th segment) from the input cloud do the following:

Step 2: Calculate x_{m,min}; x_{m,max} and width of m-th segment by using the Cumulative dimension estimation algorithm (see above).

Step 3: If (x_{m,min}−xₘᵢₙ)>x_{left} and (x_{m,max}−xₘₐₓ)<x_{right} then merge m-th segment to the parent segment.

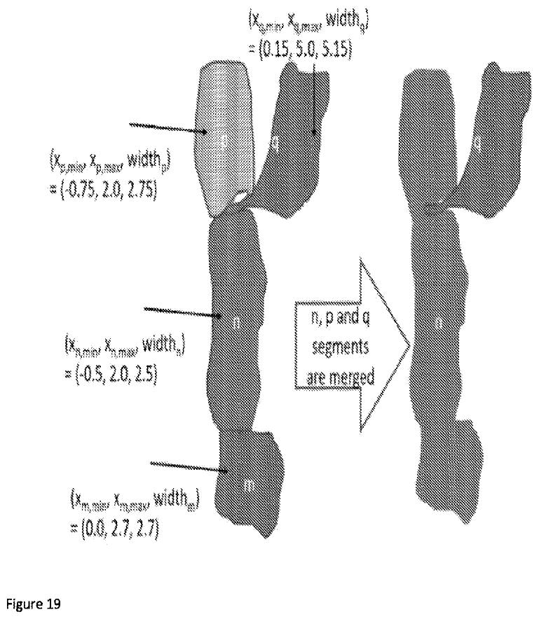

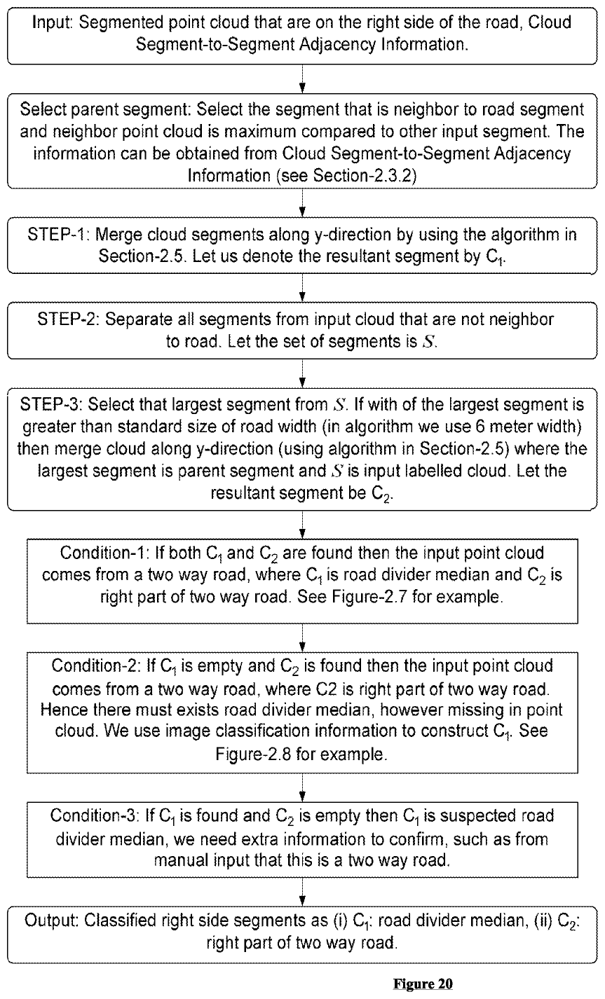

FIG. 19 shows an example of merging segments along the y-direction. Here, n-th segment is the parent segment. We see that m-th and p-th segment satisfy the condition in Step 3. Therefore, they merged with the n-th segment.

The next step is the classification of the right side median strip. Given a segmented point cloud that is on the right side of the road, we separate segments that construct the right side median. The flowchart of the algorithm is shown in FIG. 20.

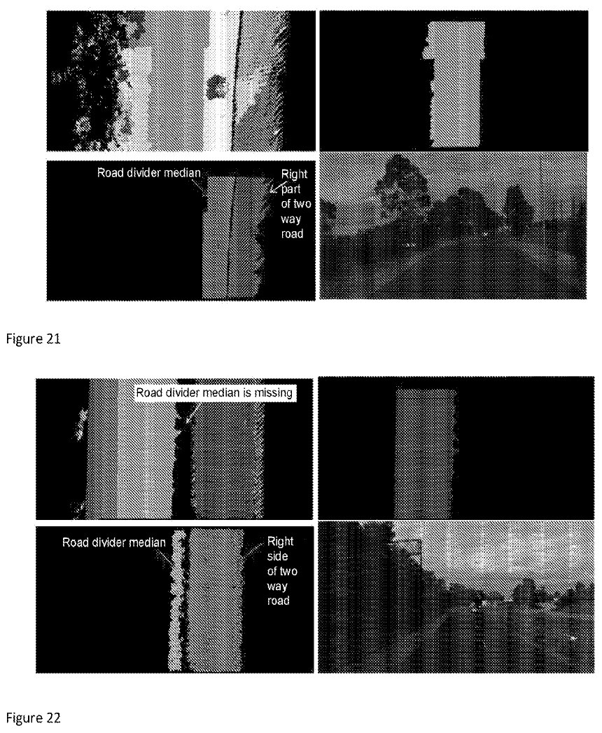

FIG. 21 illustrates Condition-1 of Right side median classification described in FIG. 20. The top left image is the Input segmented point cloud, top right is the Road part of the input cloud, bottom left shows how the Road divider median and right part of two way road are classified, bottom right shows the Imagery view around the point cloud location.

FIG. 22 illustrates Condition-2 of Right side median classification described in FIG. 20. The top left shows the Input segmented point cloud. The road divider cloud part is missing. The top right shows the Road part of the input cloud. The bottom left shows the Road divider median is accumulated from imagery classified data and the right part of a two way road is classified from point cloud. Bottom right shows the Imagery view around the point cloud location.

The next stage is the detection of vertical walls or fences. We describe above how to primarily classify some segments as prospective vertical segment candidates. However, the candidates can be over-segmented, i.e., one wall can be fragmented into multiple parts.

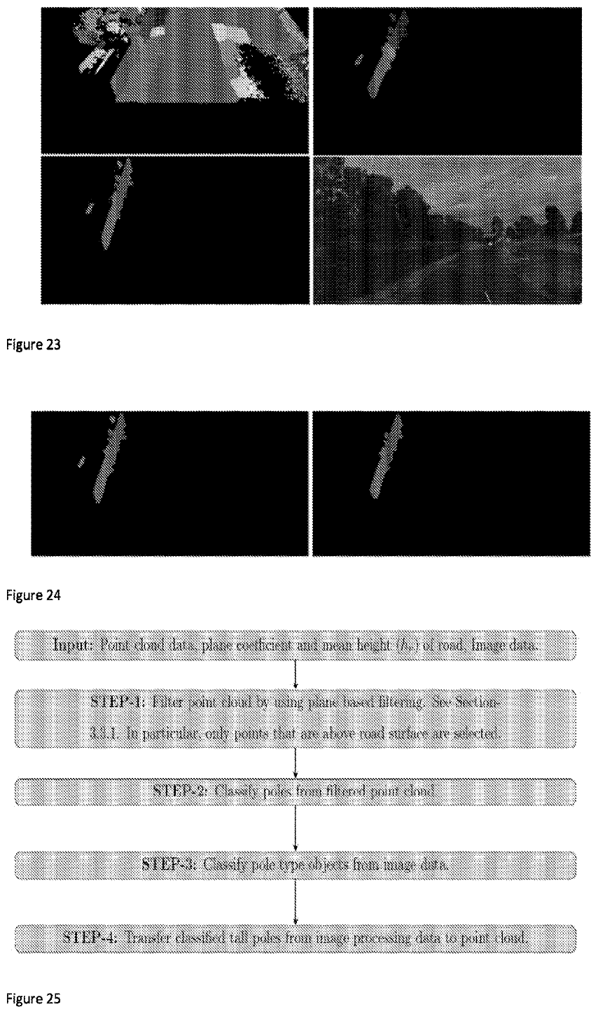

FIG. 23 shows an Input segmented point cloud in the top left. At top right, vertical segments are detected by primary classification. We see that a wall is fragmented into three parts. To join the fragmented parts, we apply Euclidean clustering algorithm on all candidate point cloud segments repeatedly. The result is shown in FIG. 23, bottom left. At bottom right, the imagery view around the point cloud location is shown. However, we show in the figure that there exists some false walls. To take final decision on wall/fence object we use the following hypothesis:

Hypothesis 1: If the y-direction length of a vertical segment large, then it is a wall/fence. To check this we set a y-length threshold, in this case vₜₕ=8 meter.

Hypothesis 2: If xz-aspect ratio of vertical segment is small, and y-direction length is medium, i.e., vₜₕ=2 then it is wall/fence, where:

$$xz aspect ratio = \frac{x direction length}{z direction length} .$$

By using those hypothesis we remove false vertical walls. FIG. 24 shows an example. At left, the primary wall candidates can be seen. The true wall is detected after applying the hypothesis 1 and hypothesis 2.

### Pole Detection

The next section is concerned with detecting poles. The road can be modelled as a plane in a small slice of point cloud data. Given the plane fitting coefficient and mean height of road part, we develop a process to extract pole from mobile LiDAR point cloud and image data. This is preferably based upon the processed point cloud data set produced as described above, but may be applied to a point cloud data set with road surface identified, according to another process.

Given the road plane fitting parameters of a point cloud data, we have determined that most of the poles can be modelled as a vertical cylinder rising from the road plane. We develop a procedure that extract pole type objects.

If the pole object data in point cloud is noisy then cylinder detection may not be successful. We observe that image based pole detection algorithm sometimes detect such missing poles. However, transferring the image processing information to point cloud is difficult. In particular, accurately projecting image data onto point cloud is almost impossible due to uncontrolled variation of pitch-roll-yaw angle of camera carrying car. We develop a procedure to combine image based pole detection result and point cloud for improved pole detection accuracy. The process is outlined in FIG. 25.

In a road-view LiDAR data, road is the best candidate that can separate road side objects efficiently. We show above that the road can be modelled as a flat plane for a small sliced point cloud data. We can extract road plane coefficient (a; b; c; d) and mean road height (hᵣ). Given this we can always define a plane in 3D space. For example, a plane can be defined at any point (x; y; z) by using the following equation,

$$\frac{a}{c} x + \frac{a}{c} y + \frac{d}{c} = z . \qquad ( 3.1 )$$

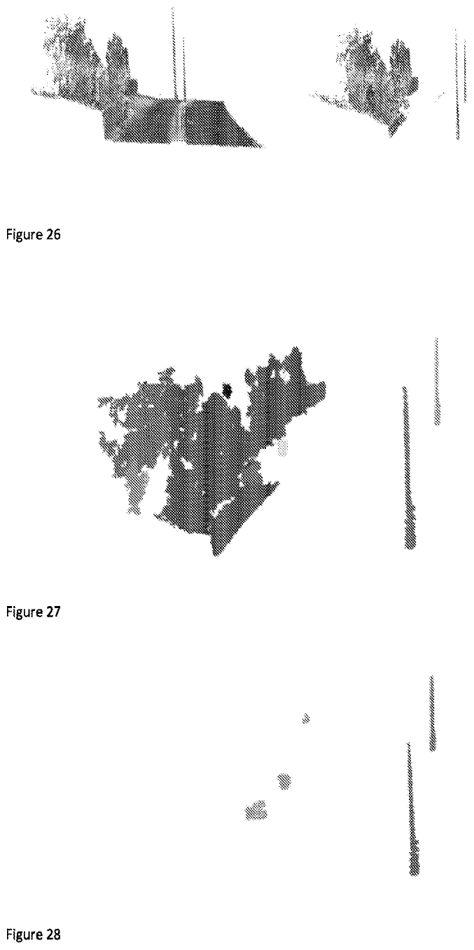

Given a height threshold hₜₕ and equation (3.1), we can filter the input cloud points whose z value is greater than hₜₕ. We call this filtering as ‘plane based filtering’. FIG. 26 shows a test input point cloud. After extracting the road plane coefficient we perform plane based filtering height threshold hᵣ+1:0, i.e., we keep all points which are a prespecified distance (e.g. 1.0 metre) above the road. The left hand image on FIG. 26 shows the output. We see that pole and tall trees are separated from ground part. Of course, it will be understood that the 1 m height could be increased or decreased for the specific data being assessed.

Given the road plane based filtered data as shown in FIG. 26 (right), we can apply a RANSAC based cylinder search algorithm. However, we do not apply RANSAC directly as this process generates many false cylinder segments. For example, if there exist some tree branches on top of a pole then the resultant cylinder will include some tree branches with the pole object.

To overcome the difficulty, we first apply a Euclidean distance based clustering on the filtered data. The result is shown in FIG. 27. We see that the main cloud is segmented into many small parts. In particular, poles are separated into two different segments. Given the segmented point cloud we apply RANSAC cylinder search for every segment independently. The result is shown in FIG. 28.

A cylinder model can be defined by 7 parameters. They are centre of cylinder (x₀, y₀, z₀), radius r and a unit vector e=[eₓ, e_{y}, e_{z}]^{T} which defines the axis of cylinder. Here [⋅]^{T} denotes transpose of a vector.

We first discuss a least squares approach for cylinder modelling. Suppose we have \hat{N} points in 3D coordinates. The k-th point is denoted in vector form by pₖ=[xₖ, yₖ, zₖ]^{T}. The cylinder can be modelled by using the following steps:
L-1: Calculate centroid of all points. Denote the centroid point by p̅₀=[x₀, y₀, z₀]^{T}. This is the centre of the cylinder.
L-2: Let pₖ=pₖ−p̅₀ for k=1, 2, . . . ·\hat{N}. Construct the matrix A=[p₁, p₂ . . . p_{N}]^{T}. The size of the matrix is \hat{N}×3.
L-3: Perform singular value decomposition of A, i.e., decompose A into three matrices U∈ [symbol] ^{\hat{N}×3}, S∈ [symbol] ^{\hat{N}×3} and V∈ [symbol] ^{3×3}, such that A=USV^{T}. Here S is a diagonal matrix whose diagonal elements are the singular values. Suppose the magnitude of n-th diagonal component of S is the largest. The n-th column of V is the axis vector e of the cylinder.
L-4: Select a point pₖ[ₖ, yₖ, zₖ]^{T} from input points. The shortest distance from pk to the cylinder axis is:

$${\tilde{d}}_{k} = \frac{\vert ( {p}_{k} - {\overline{p}}_{0} ) \times e \vert}{\vert e \vert} \qquad ( 3.2 )$$

where (×) denotes the cross product between two vectors.

$$r = \frac{1}{\hat{N}} {{\sum }_{k = 1}}^{\hat{N}} {\tilde{d}}_{k} .$$

L-5: The radius of the cylinder is:

By using eq. (3.2), it can be verified that the shortest distance from pₖ to the cylinder surface is:

dₖ=|\tilde{d}ₖ−r| (3.3)

We will now describe a RANSAC based approach for cylinder modelling. Suppose we have N data points in 3D coordinate and we want to fit a cylinder model by using RANSAC. The algorithm is described below:
Input: N data points in 3D coordinate. Let the set of all data points be P. Set an inlier threshold value T and number of iterations T. Select a value for \hat{N}. In this simulation, \hat{N}=10.
Initialize: Let M be an empty set. Define Cₘₐₓ=0
Loop-1: For i=1 to T, do the followings:
   Step-1: Select \hat{N} data points randomly from P.
   Step-2: Estimate cylinder centre p̅₀=[xₒ, yₒ, zₒ]^{T}, radius r and axis e=[eₓ, e_{y}, e_{z}]^{T} by using steps L-1 to L-5.
   Step-3: Ser s=0.
   Loop-2: For k=1 to N do the following:
      Step-3.1 Let the k-th point from P is (xₖ, yₖ, zₖ). Calculate d by using (3.3).
      Step-3.2 If d<τ then s=S+1
   End Loop-2
   Step-4: if s>Cₘₐₓ then
      Step-4.1: M={x₀, y₀, z₀, r, eₓ, e_{y}, e₂} and set Cₘₐₓ=s.
End Loop-1
Output: The cylinder model parameters M.

However, some false poles are also detected. We fix this in the following section.

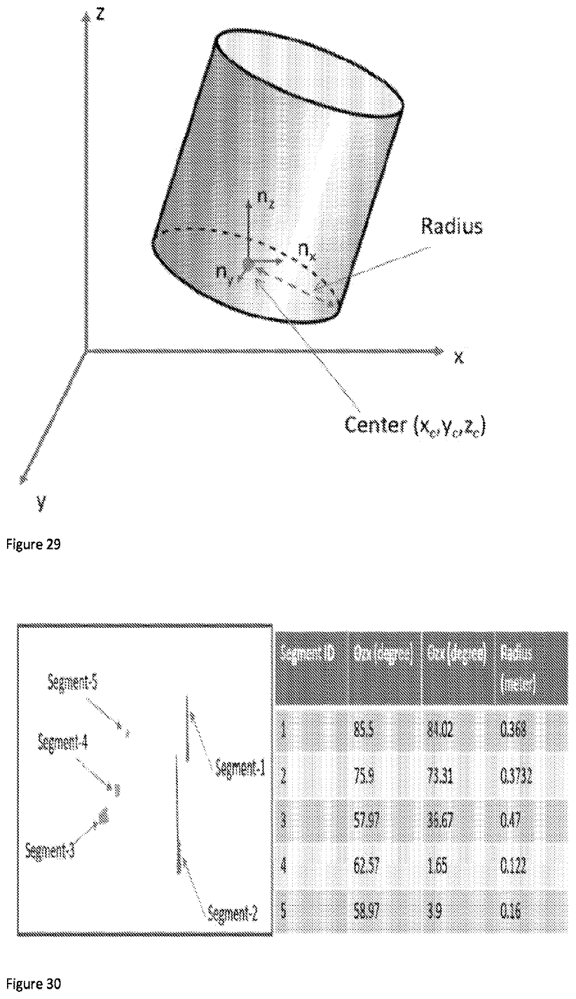

Every cylinder shaped object can be modelled by seven parameters: centre of the cylinder (x_{c}; y_{c}; z_{c}), normal strength along three axis (nₓ: n_{y}: n_{z}) and radius r. See FIG. 29 for an example. The z-x tilt angle and z-y tilt angle of the cylinder can be calculated as, respectively,

$${θ}_{zx} = {tan}^{- 1} ( \frac{{n}_{z}}{{n}_{x}} ) , \qquad ( 3.2 )$$

$${θ}_{zy} = {tan}^{- 1} ( \frac{{n}_{z}}{{n}_{y}} ) \qquad ( 3.3 )$$

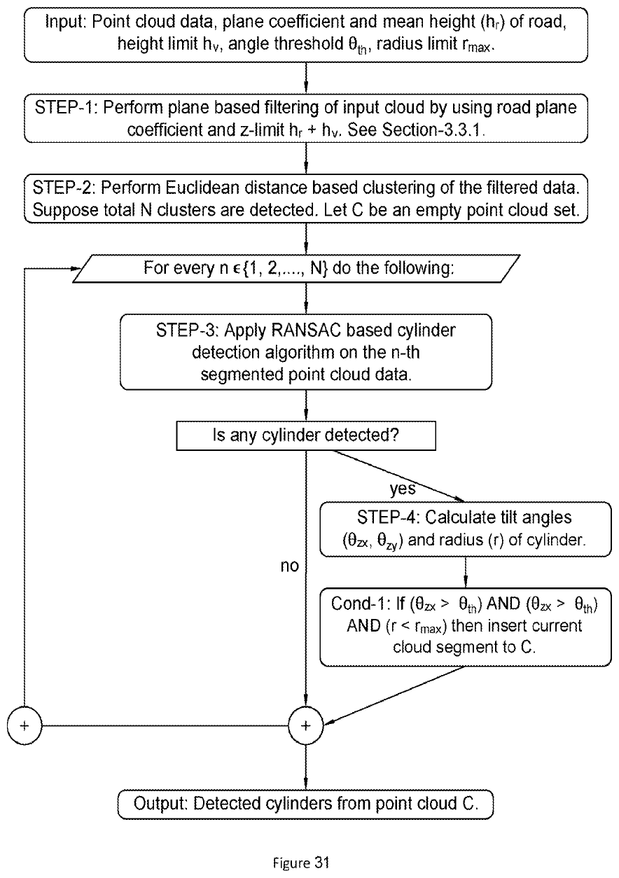

If a cylinder is perpendicular on x-y plane then both θ_{zx} and θ_{zy} will be 90°. Consider the cylinder shaped segments in FIG. 30 (left). We compute θ_{zx}, θ_{zy} and radius of different cylinder segments in FIG. 30 (right). We know that a pole creates an almost vertical cylinder in point cloud data. As can be seen, θ_{zx} and θ_{zy} are above 70° for true poles i.e., segment-1 and segment-2. Furthermore, the radius of those segments remains below 0.4 metre. We can use those parameters to separate true poles from false candidates. The flowchart of the algorithm for pole detection from point cloud data is given in FIG. 31.

The algorithm in FIG. 31 performs very well for pole detection from point cloud data. However, if the point cloud is very noisy or pole is occluded by tree branches then the algorithm will produce inaccurate cylinder parameters and Cond-1 of FIG. 31 may fail. For a precaution, we combine image processing based pole classification data for better performance.

Given camera snapshot of the input point cloud location, we apply a deep-learning framework called DeepLab [3], which can classify tall poles very accurately, whereas it will often detect false poles as small pole like objects. Therefore, we only transfer information for large classified poles from image to point cloud.

The first step is projecting point cloud data to image points. To do this we need to know the camera projection matrix [4]. Given the world points (cloud point) w=[x; y; z]^{T} and its associated image points g=[u; v; 1]^{T} the camera projection matrix C performs the following transform

λg=Cw (3.4)

where λ is a scalar. In practice, C is estimated from test data [4]. Suppose P is a given point cloud and I is the camera image view of the location. We choose a set of points from P and its associate points from I. Then solve (3.4) for C. The estimated C will remain the same for different point cloud data if the camera relative orientation with respect to point cloud orientation remains the same. However, in the current case the camera is mounted on a vehicle. It is not possible to perfectly record roll-pitch-yaw angles of the vehicle when a camera snapshot is taken. Hence C will change from one snapshot to another. In our case we always found a small shift after the transformation in (3.4).

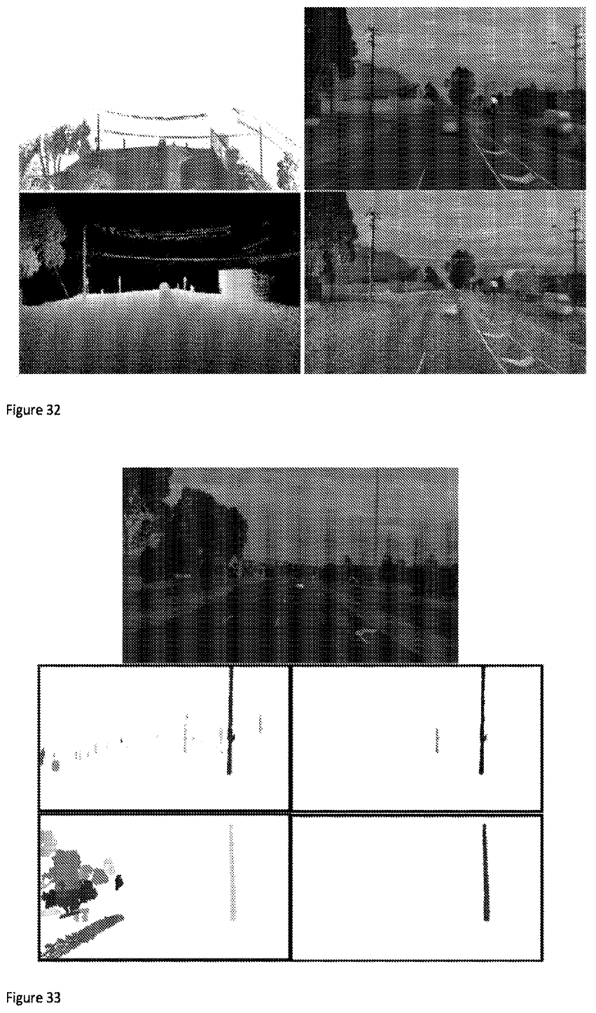

FIG. 32 shows an example. A test point cloud is transformed to the image domain. Top left shows the test point cloud. Top right shows the camera image at the point cloud location. Bottom right shows the overlay of the transformed point cloud intensity image on the camera image. We see that the transformed image does not perfectly match with the camera image. In particular, there exists a small shift on the left side pole.

The classified image based data is transferred to the point cloud. We only transfer the information of large poles that are detected in image processing. For a given image, let A be a segmented mask where every segment in A indicates individual pole. Let Aₙ be a mask constructed from A by retaining the n-th segment. We predict the height of a pole by using the following procedure:

Pole Height Prediction: Project Aₙ onto the y-axis. Let the projected vector be a_{n,y}. The indices of first and last non-zero components of a_{n,y} are iₘᵢₙ and iₘₐₓ respectively. We use pₙ=iₘₐₓ−iₘᵢₙ as an indicator of height information of n-th pole. If pₙ is larger than a threshold, pₜₕ, then we select that pole as a tall pole. Denote the resultant mask of all tall poles by Â, FIG. 33 shows an example. We select tall poles whose height are greater than a predetermined number of pixels (e.g. pₙ=40 pixels).

In the second step, we process point cloud data. Given an input point cloud we perform plane based filtering followed by Euclidean distance based segmentation (see Step-1 and Step-2 of FIG. 31). We transform the segmented point cloud to image points i.e., in pixel domain by using equation (3.4). Let B be the segmented mask generated by transforming point cloud to image point. We then select all segments whose predicted heights are above the threshold pₜₕ. The resultant mask will be denoted by \hat{B}. FIG. 33, bottom image, shows an example.

Referring to FIG. 33, the top is the Test image; middle left are pole like objects detected by image processing; middle right are separate tall poles with height greater than pₜₕ=40 pixels. The resultant mask of all tall poles is denoted by Â. Bottom left is a projection of Euclidean distance based segmented point cloud on image space. Bottom right shows separate objects from projected point cloud image with height greater than pₜₕ=40 pixels. The resultant mask is denoted by \hat{B}.

Step 3 of this process is matching image data to projected point cloud data. Suppose there are M segments in \hat{B} and N segments in Â. Let height of i-th segment of Â be hⱼ. Relabel the segments in Â such that h₁>h₂> . . . h_{N}. Set a threshold value dₜₕ and an empty mask P. n∈{1, 2, . . . N} do the followings:
Step-3.1: Construct Âₙ by retaining the n-th segment from Â. Compute central contour of Âₙ by using the procedure described in Chapter-1, Section-1.5.3. Let the central contour be q=[x₁, y₁), (x₂, y₂), . . . (xₛ, yₛ)] where we set s=6.
Step-3.2: For m∈{1, 2, . . . M} do the following
   Step-3.1.1: Construct \hat{B}ₘ by retaining the m-th segment from \hat{B}. Compute central contour of \hat{B}ₙ. Let the central control be q̅=|\hat{x}₁, ŷ₁), \hat{x}₂, ŷ₂), . . . (\hat{x}ₛ, ŷₛ)|.
   Step-3.1.2: Compute:

$$d = \frac{1}{s} {{\sum }_{i = 1}}^{s} \sqrt{{x}_{i} - {\dot{x}}_{i}} + \sqrt{{y}_{i} - {\dot{y}}_{i}} .$$

Step-3.1.3: If d<dₜₕ then \hat{B}ₙ is a true pole in point cloud. Merge \hat{B}ₙ to P. Remove \hat{B}ₙ from B. Go to Step-3.1.

The output of the algorithm is the mask P that indicates the poles in point cloud image.

### Tree Detection

The next section is concerned with tree detection. Given the plane fitting coefficient and mean height of road part, we disclose a machine learning technique to extract trees from mobile LiDAR point cloud data. It will again be appreciated that the present aspect can be used with the point cloud data processed as previously described, or with a point cloud data set which has been processed to extract the road surface, etc using other techniques.

The main principle used here is that every tree canopy can be segmented into one or multiple parts where every part can be modelled as a dome type structure. Note that this principle may not be valid for tree detection in forest environments, however, this is very efficient for road side tree detection. A suitable point cloud segmentation algorithm is chosen which can segment trees from other objects while preserving the dome type structure. An efficient feature extraction technique is disclosed that extracts the discriminating feature of trees and allows their detection.

The first stage is preprocessing using plane based filtering. Given road plane coefficient and mean height hᵣ we filter the input cloud points whose z value is greater than hᵣ+1.0 metre. This process has been previously described.

In general, many tree canopies have a random structure. However, if we observe tree branches separately then most of them have a dome structure. We have to select a point cloud segmentation algorithm that can preserve the structure. We found that the Locally Convex Connected Patches (LCCP) based point cloud segmentation algorithm [5] gives the most desirable result. LCCP is a simple segmentation algorithm partitioning a supervoxel graph into groups of locally convex connected supervoxels separated by concave borders.

Given a point cloud dataset, the Locally Convex Connected Patches (LCCP) algorithm (see reference [5]) works in the following steps:

### Building the Surface-Patch Adjacency Graph

First, create a supervoxel adjacency graph by using the procedure described above in [0072]. The procedure will partition the input point cloud into supervoxels. For every supervoxel, it calculates centroid pᵢ=[xᵢ, yᵢ, zᵢ]^{T}, normal vector nᵢ, and set of edges to adjacent supervoxels Nᵢ. To perform final cloud segmentation, some criteria are derived from supervoxel parameters.

### Extended Convexity Criterion

Classifying whether an edge eⱼ that connects two supervoxels is either convex (i.e., true) or concave (i.e., false). The convexity of every edge is decided by using equation 1.5 above.

### Sanity Criterion

Suppose the edge eᵢ is separating supervoxels j and k. Calculate di by using equation 1.5. The direction of intersection of the planes approximating the supervoxel surface is sᵢ=nⱼ×nₖ, where (×) denotes cross product between two vectors. The sanity angle is defined as the minimum angle between the two directions

ϑᵢ=min(cos⁻¹(dᵢ^{T}sᵢ),180°−cos⁻¹(dᵢ^{T}sᵢ)) (1.11)

The sanity criterion SC is then defined as

$${SC}_{i} = \{ \begin{matrix}true , & if {ϑ}_{i} > {ϑ}_{th} \\ false , & otherwise\end{matrix} \qquad ( 1.12 )$$

where ϑth=60°.

### Locally Convex Connected Patches (LCCP) Segmentation

Given the supervoxel graph that is extracted above, we first partition the graph by using the Extended Convexity Criterion. Then partition the graph again by using the Sanity criterion.

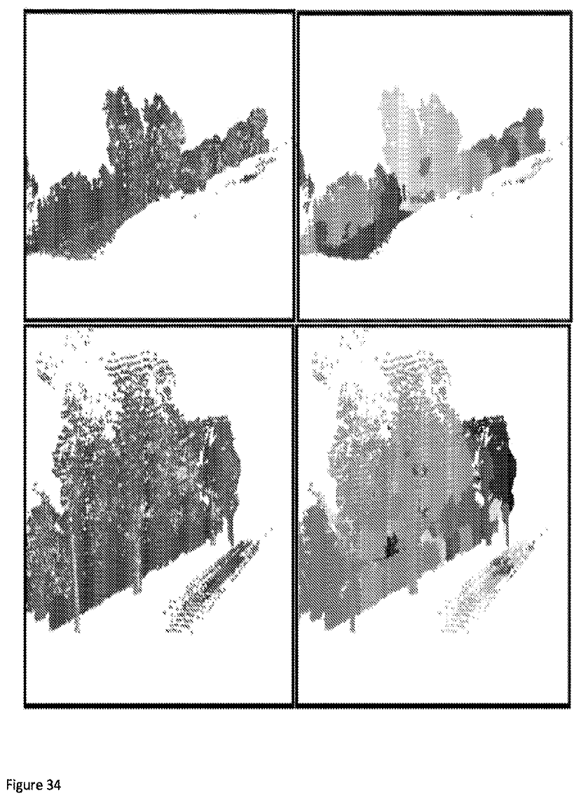

FIG. 34 shows some point cloud segmentation results. At top left is the test point cloud I; top right, segmentation using the LCCP algorithm. It can be seen that the algorithm separates most of the trees as individual segments. In some cases, the tree is fragmented into multiple parts, however, most of the tree segments have a dome shape.

Many feature extraction techniques exists for 3D point cloud data. Here we consider a few of them and compare their performance for feature extraction from tree segments.

FPFH (Fast Point Feature Histogram) is proposed in reference [6]. For a given point cloud, FPFH starts a loop. At each round it samples one point (pᵢ) randomly and selects all neighbouring points within a sphere around p with the radius r. Given the point set, four features are calculated which express the mean curvature of the point cloud around the point pᵢ.

Viewpoint Feature Histogram (VFH) is a descriptor for a 3D point cloud that encodes geometry and viewpoint (see reference [7]). To calculate the VFH feature of a point cloud we need a viewpoint, i.e., a (x, y, z) location from where a viewer is observing the cloud. If the viewpoint is unknown, the centre of the axis (0, 0, 0) can be used. The VFH consists of two components: (i) A viewpoint component and (ii) an extended Fast Point Feature Histogram (FPFH) component (see reference [6]).

We first compute the viewpoint components. Given a point cloud cluster, the algorithm first computes surface normal at every point of the cloud. Let the i-th point and its associated surface normal be denoted by pᵢ and nᵢ respectively. For a pair of 3D points (pᵢ, pⱼ), and their estimated surface normals (nᵢ, nⱼ), the set of normal angular deviations is estimated as:

$$α = {v}^{T} {n}_{j} \qquad ( 1.13 )$$

$$ϕ = {u}^{T} \frac{{p}_{j} - {p}_{i}}{{‖ {p}_{j} - {p}_{i} ‖}_{2}}$$

$$θ = arctan ( {w}^{T} {n}_{j} , {u}^{T} {n}_{j} )$$

where u, v, w represent a Darboux frame coordinate system chosen at pᵢ. For the given point cloud data set, the direction of axis of Darboux frame is defined by combining the directions of surface normal of all points on the cloud. The viewpoint component at a patch of points P={pᵢ} with i={1, 2, . . . , n} captures all the sets of (α, φ, θ) between all pairs of (pᵢ, pⱼ) from P, and bins the results into a histogram. This is called Simplified Point Feature Histogram (SPFH).

Now we calculate extended Fast Point Feature Histogram (FPFH) by using SPFH. Select a value of k for neighbour search. For every point pᵢ on the point cloud, select k-closest neighbours around it. Let the patch of k selected points be P. Compute SPFH(pᵢ). Extended Fast Point Feature Histogram (FPFH) is a reweighed copy of SPFH:

$$FPFH ( {p}_{i} ) = SPFH ( {p}_{i} ) + \frac{1}{k} {\sum }_{j = 1 ; j \neq i}^{k} \frac{1}{{ω}_{j}} SPFH ( {p}_{j} ) \qquad ( 1.14 )$$

where the weight wⱼ represents the distance between query point pᵢ and a neighbour point pⱼ.

The Clustered Viewpoint Feature Histogram CVFH [8] extends the Viewpoint Point Feature Histogram (VFH). It subdivides the point cloud into clusters (stable regions) of neighbouring points with similar normals. The VFH is then calculated for each cluster. Finally, the shape distribution components are added to each histogram.

ESF (Ensemble of Shape Functions) is described in reference [9] For a given point cloud, ESF starts a loop that runs (for example) 20,000 times. At each round it samples three points randomly (pᵢ, pⱼ, pₖ). Then it computes the following features:

F1: For pairs of two points calculate the distance between each other and check if the line between the two lies on the surface, outside or intersects the object.

F2: For the previous line find the ratio between parts of that line lying on the surface or outside.

F3: For triplets of points build a triangle and calculate the square root of the area of the triangle that is inside and outside of the point cloud surface.

It is possible to use the feature extraction techniques discussed in order to classify objects as trees. Suppose we want to use a specific one of these techniques (LCCP, FPFH, VFH, CVFH, ESF or some other technique) for object classification. This process has two steps: (i) training, and (ii) testing. Given a set of training data,

### Training

Step 1: Compute features for all training samples.

Step 2: Create a KDTree by using the training features set. A k-d tree, or k-dimensional tree, is a data structure used for organizing some number of points in a space with k dimensions. It is a binary search tree with other constraints imposed on it. K-d trees are very useful for range and nearest neighbour searches.

### Testing

Given a test data we use nearest neighbour search for classification. For this we need a distance threshold fₜₕ.

Step1: Compute feature of the test sample.

Step2: Search the nearest neighbour index and distance of the test feature from the training features set by using the KDTree that was built in training stage.

Step3: If the distance is smaller than fₜₕ then the test data is classified as true class, otherwise, false class.

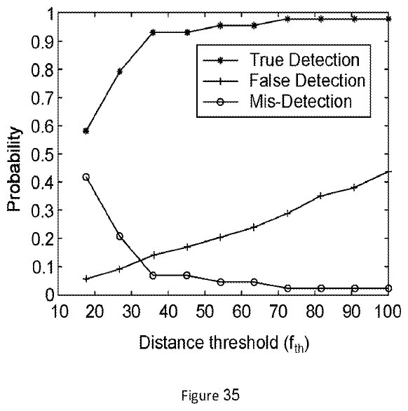

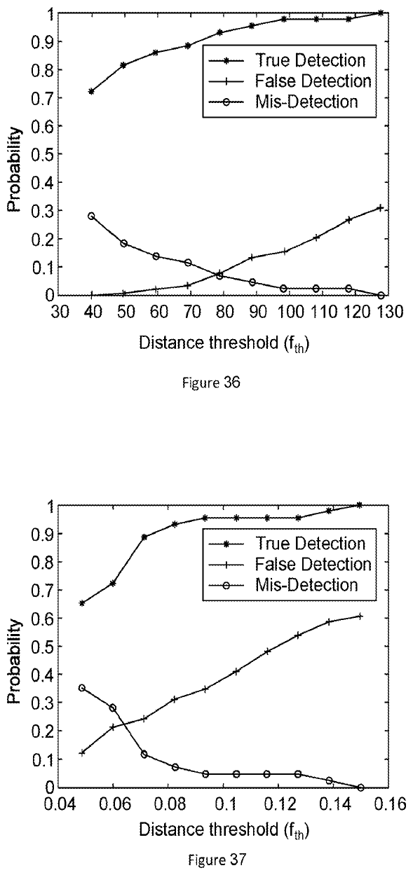

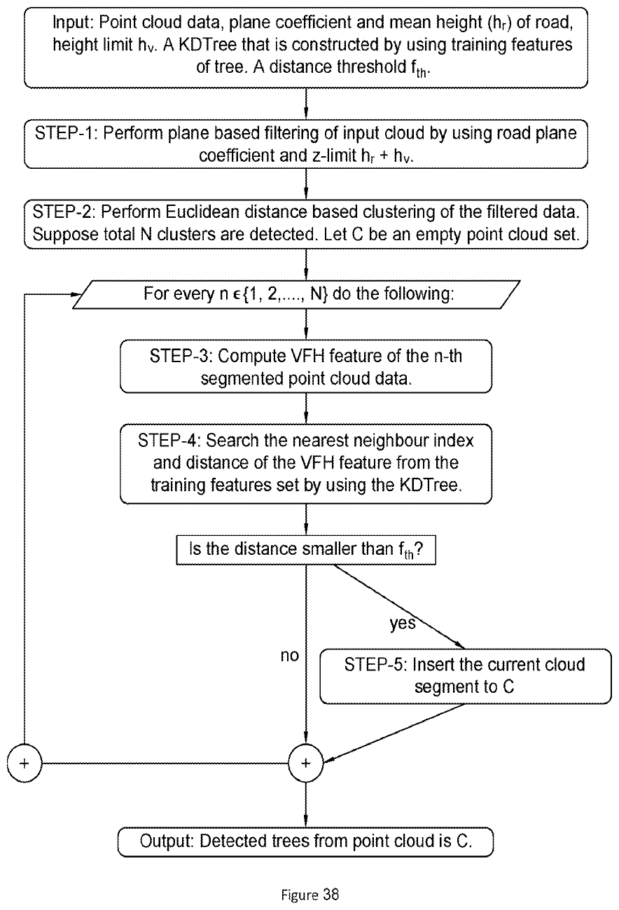

We conducted an experiment to test efficiency of different techniques for tree detection. The result is shown in FIGS. 35, 36 and 37. FIG. 35 is for VFH, FIG. 36 for CVFH and FIG. 37 ESF. For a distance threshold fₜₕ=36, VFH gives true detection and false detection probability 0.93 and 0.14 respectively. For CVFH, the true detection is 0.953 and false detection 0.134 with distance threshold value 88.

EFS did not perform as well as the other approaches. In summary, CVFH performs little better than VFH. However, the computational complexity of CVFH is higher, and accordingly we prefer VFH for tree detection.

### Further Aspects of Road Detection Algorithm

The road detection algorithm described above may be employed successfully depending upon the quality of the original data. However, we describe below some enhancements to those algorithms.

One limitation arises when Applying Constrained planar cuts (CPC) for road surface segmentation. The CPC segmentation algorithm works well if the point cloud data exhibits clear convexity at the intersection of two planes. We apply this principle to separate road surface from roadside curbs, safety walls etc. However, the point cloud data on road surface can be rather noisy due to moving vehicles road surface noise etc. Some examples are given in FIG. 4C to FIG. 4F. As a result, the road surfaces are fragmented randomly.

We improve this by combining road surface normal and intensity gradient normal followed by some efficient thresholding techniques as pointed out in point (c) below.

Another aspect relates to the limitations of mapping image data to point cloud data that is described above.

One limitation is that this process requires a camera projection matrix. The underlying camera used for the illustrative imaging is a Ladybug camera which takes 5 snapshots simultaneously. The resulting images are stitched together to produce a 360° panorama image. The camera projection described above is based on a pinhole camera model which only captures the camera projection system approximately.

A further issue is that according to the process described above, we cannot correctly identify the camera location and its pitch, yaw and roll angles. As a result, we cannot align point cloud and image if the road curvature is more than 5 degrees.

Therefore, we improve the “Data projection system” as explained below.

### Updated Road and Lane Marking Detection Algorithm:

Overview of this Implementation:

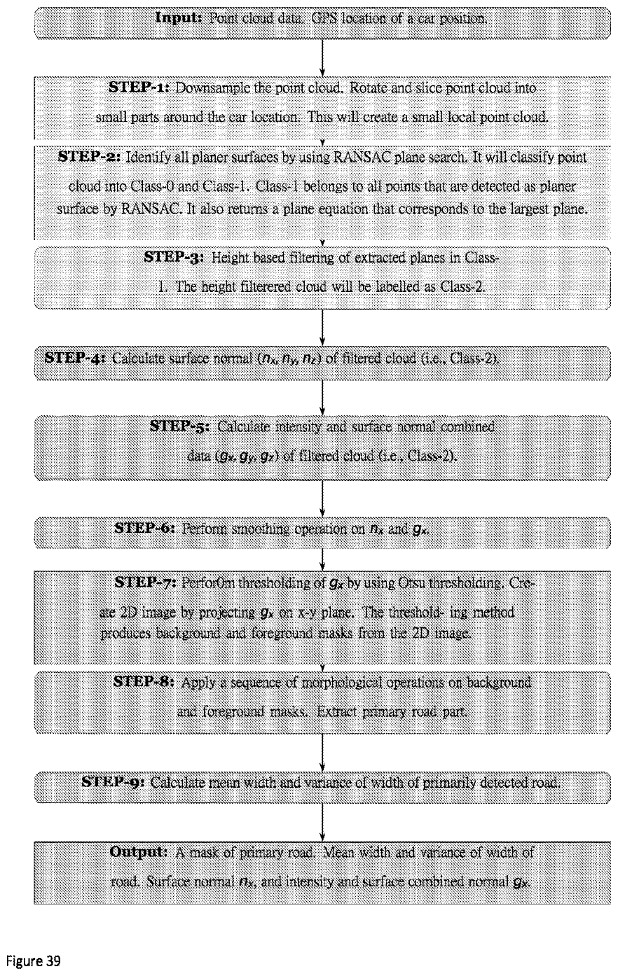

FIG. 39 provides an overview of the road detection process. The road detection and line marking identification process according to this implementation of the present invention has three parts:

Part-I: Local point cloud data processing: This part takes a small part of point cloud as input. It will produce the following outputs:
Classified input point cloud data. Point cloud data will be classified into class-0, class-1 and class-2. A RANSAC based plane searching algorithm is used for the classification, where class-1 represents the points which are detected to be fall on some planes by RANSAC, class-2 is the subclass of class-1 points whose height values are below a threshold and class-0 are the residual points.
Calculated surface normal (nx), and intensity gradient and surface normal combined data (gx) of all points of class-2. Then project the quantities on x-y plane.
This will create two 2D images.
Primary road detection mask based on (gx) image.
Mean width and variance of width of primarily detected road.

Part-II: Consistency check and final road detection: The part will take outputs of Part-I as inputs and produce the following output:
Check inconsistency of primarily detected roads from successive local point cloud data and classify point cloud data into final road class.

Part-III: Lane marking detection: The part has the following inputs:
Intensity gradient (gx) as calculated in Part-I.
GPS locations of car moving trajectory.
Road class which is detected in Part-II.

It will produce the following outputs:
Identify lane markings of point cloud.

The inventors have observed that the mobile LiDAR signal that returns from flat surface creates an interesting regular shape. To exploit this feature, a large block of point cloud data is sliced into small blocks, where every small block is related to some known position information. Surface normal components of the cloud exhibits a discrimination property on flat and smooth surfaces compared to roadside curb and non-smooth plane. However, this is not always sufficient for road identification. We combine the normal component to local intensity gradient of point cloud to classify road type surfaces very efficiently.

As will be described below, the inventors have developed an efficient process which applies a sequence of customized filters that remove many false road candidates from the input point cloud. Then apply the above principle to approximately identify road separating curb and road boundary lines. The resultant 3D point cloud is projected to a 2D image. Some efficient morphological operations are then applied to identify road and road markings. A process is described which can identify when the algorithm cannot detect road properly.

A procedure for lane marking detection and clustering is further described below, where every cluster is associated to a particular lane boundary contour. The clustering process is difficult for curved roads. Conventional techniques use a lane tracking algorithm, however, they cannot identify any new lane that starts inside the curved road. We describe an adaptive rotation process which does not need curve tracking.

### Local Point Cloud Data Processing

The flowchart of Part-I is given in FIG. 39. Suppose we have N GPS locations of the surveillance car trajectory where camera snapshot was taken. The following process is applied for every n={1, 2, . . . N} car location independently.

Step-1 and Step-2 of FIG. 39 are outlined in the description above in relation to the earlier discussion of local point cloud processing, (i.e., [0083]-[0086]).

In Step-2 of FIG. 39, class-1 refers to the points that are classified as planes i.e., (P). Class-0 refers to those points which are not classified as plane.

Step-2 of FIG. 39 returns a plane equation that corresponds to the largest plane in the plane search. Step 3 is to perform height based filtering of the extracted planes. The mean height of largest plane is denoted by hᵣ. The largest plane equation gives us the primary road plane coefficient (a; b; c; d). Given this we can always define a plane in 3D space. For example, a plane can be defined at any point (x; y; z) by using the following equation,

$$\frac{a}{c} x + \frac{a}{c} y + \frac{d}{c} = z . \qquad ( 3.1 )$$

Given a height threshold hₜₕ and equation (3.1), we can remove the input cloud points whose z value is greater than hₜₕ. In our application, after extracting the road plane candidates as class-1 (see Step-2 of FIG. 39), we perform plane based filtering with height threshold hᵣ+1.0, i.e., we keep all points which are below hᵣ+1.0 meters.

### Step-4: Surface Normal Calculation

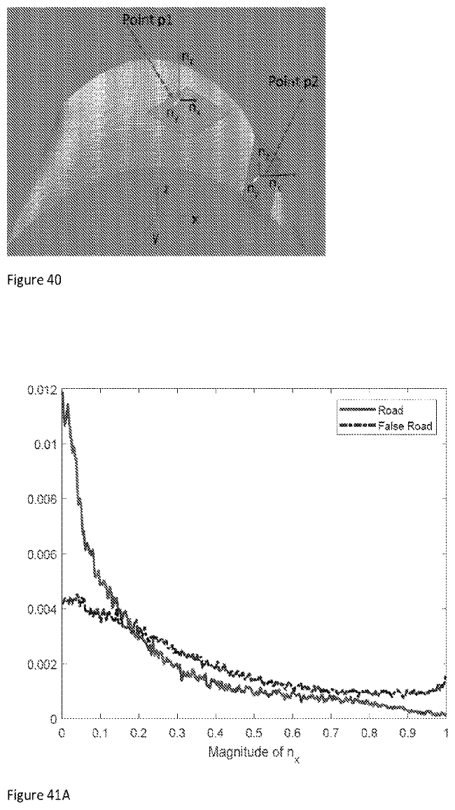

We develop a technique that combines the surface normal and intensity gradient property of point cloud to separate road surface. Different methods exist for surface normal estimation, see [20],[21] and references therein. To estimate surface normal at a point p∈R³ on a given point cloud, we need a set of points around p. For this we define a sphere where the radius of the sphere is called ‘normal radius’ and the centre of the sphere is p. The set of all points that are inside the sphere is denoted by P. We fit a plane to the points in P. The unit vector normal to this plane is the surface normal which is denoted by (nₓ, n_{y}, n_{z}). FIG. 40 shows (x, y, z) components of surface normal (i.e., nₓ, n_{y}, n_{z}) calculated at two different points on a test point cloud.

Note that the LiDAR scan trajectory on a plane surface like road is smooth. Therefore, the magnitude of some components of surface normal on road cloud should be approximately constant. However, on a non-road surface the normal components may vary randomly. We need to sort out a normal component that exhibits distinguishing property on the road. For this, we separate different normal components i.e., |nₓ| and |n_{y}| of true road and false road from some test point cloud, where |·| denotes absolute value. We compute the distribution of the components. Note that the property of surface normal can be affected by the normal radius. Therefore, we consider three different normal radius values, i.e., 0.5, 0.25, and 0.1 meter. In our data set, the normal radius value 0.25 meter shows the discrimination more clearly. FIGS. 41 A and 41B shows the distribution. We observe that, on the true road |nₓ| remains below 0.1 with high frequency, that is about 0.08. However, for |n_{y}| there is no clear separation boundary between true road and false road.

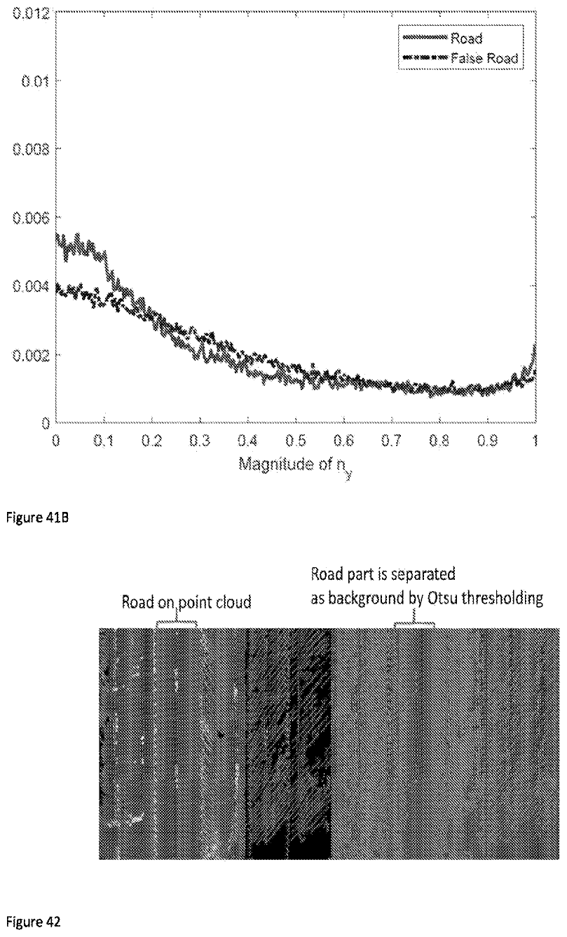

Given nₓ values of all points of a point cloud we need to apply a threshold method that can separate road from other objects. The Otsu threshold selection method [22] is perfect for our needs. The Otsu threshold gives single threshold that separates data into two classes, foreground and background. This threshold is determined by maximizing inter-class variance. FIG. 42 shows the application of the Otsu threshold method on a test point cloud. The left shows the test point cloud, the right thresholding |nₓ| of the point cloud by using the Otsu method. The red color is background and the blue color is foreground. Most of the road part is separated as background.

After applying the thresholding on the |nₓ| component we see that most of the road part is separated as background. However, there is no clear separation boundary of the road part from non-road parts. Furthermore, a fraction of the left part of the road is detected as foreground.

### Step-5: Intensity Gradient and Surface Normal Combined Data Calculation

To overcome the limitation of surface normal, we combine intensity with surface normal. FIG. 42 [Left] shows that intensity value of the point cloud generates a rough road boundary on the point cloud. To exploit the property, we apply the intensity gradient estimation method developed in [1]. The intensity gradient at a given point is a vector orthogonal to the surface normal, and pointing in the direction of the greatest increase in local intensity. The vector's magnitude indicates the rate of intensity change. More precisely, let δIₓ, δI_{y} and δI_{y} be the local intensity gradient at the point (x, y, z). Intensity and surface combined normal is estimated by projecting the intensity variation onto the surface transient plane, i.e,

gₓ=(1−nₓ²)δIₓ−nₓn_{y}δI_{y}−nₓn_{z}δI_{z}

g_{y}=−n_{y}nₓδIₓ+(1−n_{y}²)δI_{y}−nₓn_{z}δI_{z}

gₓ=−n_{z}nₓδIₓ−n_{z}n_{y}δI_{y}+(1−n_{z}²)δI_{z}

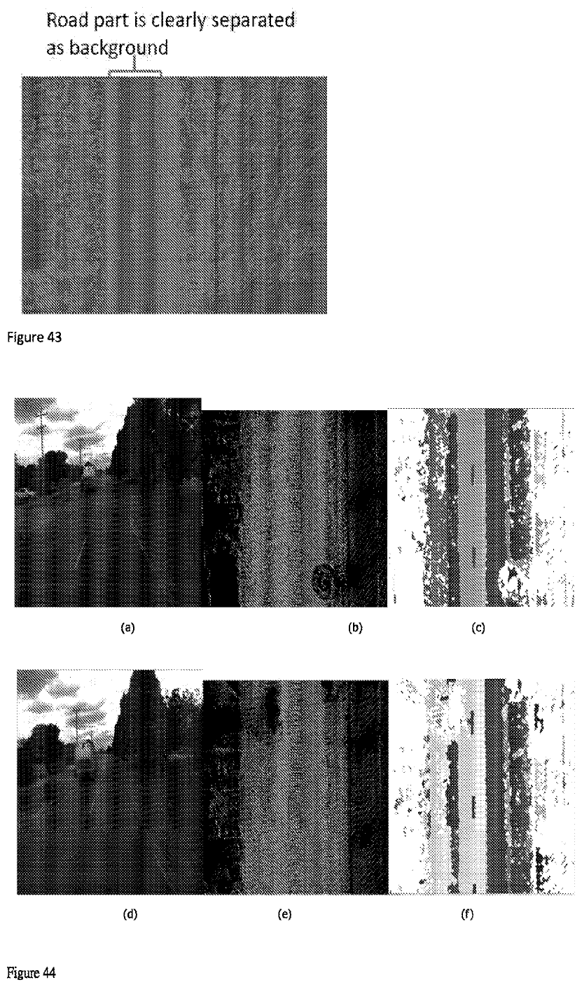

The result of applying Otsu threshold method on |gₓ|² in shown in FIG. 43. We see that road side curb and grasses create a continuous foreground boundary of road along the y-direction. This foreground segments can be used to isolate road as an independent segment. Furthermore, the lane markings are also isolated as foreground inside the road segment. The full systematic process of road detection is described in the next section.

### Step-6: Smoothing Surface Normal and Intensity Gradient

The components nₓ and gₓ are not always smooth on the road or around road corners. We apply Gaussian smoothing on nₓ and gₓ components. The Gaussian smoothing of point cloud data is not as straight forward as in a 2-D image. We need a radius value dᵣ. For a given point p∈R³, we select all points {\hat{p}ₙ}ₙ₌₁^{N} that satisfy the following equation:

∥\hat{p}ₙ−p∥₂≤dᵣ (1.11)

Let the gₓ values associated to {\hat{p}ₙ}ₙ₌₁^{N} are {g_{x,n}}ₙ₌₁^{N}. Now given a value of σ, the smoothed value of gₓ at p is

$${\ddot{g}}_{x} = \frac{1}{S} {\sum }_{n = 1}^{N} \text{?} \qquad ( 3 )$$

$$\text{?} \text{indicates text missing or illegible when filed}$$

where,

$$S = {\sum }_{n = 1}^{N} exp ( \frac{- {‖ {\hat{P}}_{n} - p ‖}_{2}^{2}}{2 {σ}^{2}} ) \qquad ( 1.12 )$$

In the similar process, we can calculate n̅ₓ by replacing g_{x,n} with n_{x,n} in (3).

### Step-7: Thresholding and 2-D Projection

The foreground and background points of the point cloud P_{F} are labelled by applying the Otsu threshold method on ∥g̅ₓ|². After labelling, every point of the point cloud can be described by a 4-D vector, [x, y, z, s], where s∈[1, 2], i.e., background or foreground. Now project the point cloud in 2-D image domain. For this, we need a grid resolution vᵣ. In the algorithm, we set vᵣ=0.075 meter. Let (xₘᵢₙ, yₘᵢₙ) be the minimum value of all (x, y) locations of the point cloud Pᵢ. Also let (xₘₐₓ, yₘₐₓ) be the maximum value of all (x, y) locations. Define a 2D image Q of height [symbol] ^{y}^{ₘₐₓ}^{-y}^{ₘᵢₙ} [symbol] and width [symbol] ^{x}^{ₘₐₓ}^{-x}^{ₘᵢₙ} [symbol] , where [symbol] , [symbol] is a ceiling operator. Let \tilde{p}=[\tilde{x}, \tilde{y}] be a pixel location in Q. Define the mapping as follows:

$$f ( \tilde{p} ) = {v}_{r} \tilde{p} + [ \begin{matrix}{x}_{min} \\ {y}_{min}\end{matrix} ] \qquad ( 1.13 )$$

Any point on Pⱼ whose (x,y) value satisfies the following equation is assigned to p̅:

$${‖ [ \begin{matrix}x \\ y\end{matrix} ] - f ( \tilde{p} ) ‖}_{2} \leq 0.5 {g}_{r} \qquad ( 1.14 )$$

Note that multiple points of P_{f} can be mapped to the image domain. Suppose N points of P_{f} are assigned to p̅⋅, they are {\hat{p}ₙ}ₙ₌₁^{N}, where \hat{p}ₙ=[xₙ, yₙ, zₙ, sₙ]. To assign a label (or pixel value) at \tilde{p}⋅ we choose the Sₘ associated to Zₘ which is the highest among {zₙ}ₙ₌₁^{N}. The reason behind this is that accuracy of LiDAR sensor measurement is more accurate if it comes from closer distance. The resulting image will be called ‘Threshold Gradient image’.

### Step-8: Image Segmentation and Primary Road Detection

The road part from Q (see FIG. 43) can be identified by removing the foreground part and then applying some connected component based segmentation (see reference [23]). However, the foreground part is not always well connected, hence, applying connected component segmentation on the background sometimes selects non-road parts. Here we apply a systematic process to separate the road part:
P-1: Separate foreground from Q. Apply morphological closing operation on foreground. Let the resultant foreground mask be Q_{f}.
P-2: Separate background from Q. Apply morphological closing operation on background. Let the resultant background mask be Q_{b}.
P-3: Remove Q_{f} from Q_{b}. Apply morphological opening operation. Let the resultant background mask be Q_{b2}.
P-4: Apply connected component based segmentation on Q_{b2}. The largest segment that is closest to the surveillance car location is identified as road. Create a binary mask Mₙ by retaining the detected road part.

### STEP-9: Calculate Mean Width and Variance of Width of Primarily Detected Road

Here we work with the 2D road mask Mₙ that is generated as described above. Let the top left corner of bounding box of the road segment is (x, y) where x is row and y is column index. The bottom right of the bounding box is (x+a, y+b). Compute

$$\begin{matrix}{w}_{i} = {\sum }_{j = y}^{y + b} {M}_{n} ( i , j ) , i ∈ \{ x , x + 1 , … x + a \} \\ {\overline{w}}_{n} = \frac{1}{a} \sum {w}_{i} \\ {\sum }_{n} = \frac{1}{{a}^{2}} {\sum }_{i} {( {w}_{i} - {\overline{w}}_{n} )}^{2}\end{matrix} \qquad ( 1.15 )$$

Where wₙ and Σₙ are mean value and variance of road width.

### Part-II: Road Inconsistency Detection

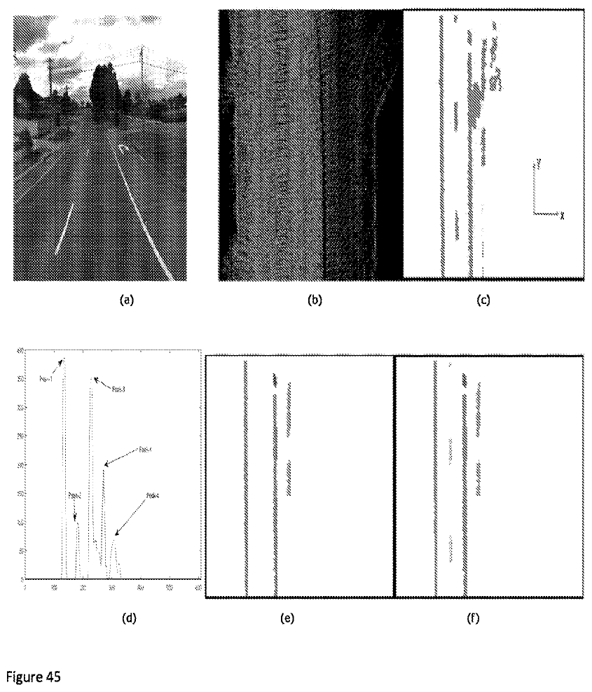

Part-I of the algorithm can detect road efficiently. However, in some cases, the road curb or road boundary line is obscured by some stationary tall objects like trucks. See for example FIG. 44, images a and d where a truck is parked at the top left corner of the road.

In such cases, the height based plane filter (Step-3 of FIG. 39) removes the upper part of truck and consequently, the road boundary cannot be detected properly. Note that the above algorithm is not affected by a moving truck, as a moving object does not create a stationary cluster in the mobile point cloud. We show results of two conjugative cloud sequences in FIG. 44.

In FIG. 44, (a) shows the camera image around the n-th point cloud segment; (b) Threshold gradient image of point cloud; and (c) Segmentation of gradient image, with road separated as one segment.

In FIG. 44, (d) shows the camera image around the n+1-th point cloud segment; (e) Threshold gradient image of point cloud; and (f) Segmentation of gradient image. The road part is mixed with footpath.

Top and bottom images are denoted by n-th and (n+1)-th sequences respectively. At the n-th sequence the truck cloud is not inside the working cloud slice. The algorithm separates the road segment perfectly. However, at sequence n+1, the truck appears at the top part of the cloud, which creates a hole in the working cloud segment. FIG. 44 (f) shows that the algorithm has mixed road with footpath.

To identify inconsistency of road detection, we compare the road width change and road width variance change of two successive sequences. Suppose we want to check inconsistency of (n+1)-th sequence. The tuple of mean width and variance of width of primarily detected road for n-th and (n+1)-th sequence are denoted by (w̅ₙ, Σₙ) and (w̅ₙ₊₁, Σₙ₊₁) respectively. Those values are calculated at Step-9 of FIG. 39. We assume that the road is detected perfectly at the n-th sequence.

If the change of mean value and standard deviation of detected roads from two successive cloud slices are larger than some thresholds then we identify a road inconsistency. If any inconsistency is detected and w̅ₙ₊₁>w̅ₙ, this means that the road boundary is not separated properly. We create another threshold gradient image by using the process described above in step 7, where |g̅ₓ|² is replaced by |n̅ₓ|². We perform a logical ‘AND’ operation on both images that are created by the |g̅ₓ|² and |n̅ₓ|² based method. Finally, we apply the operations in step 8 above on the combined image for road detection. However, if w̅ₙ₊₁<w̅ₙ then we perform a logical ‘OR’ operation on |g̅ₓ|² and |n̅ₓ|² based images followed by the process in step 8.

### Part-III: Lane Marking Detection

As outlined above, at a given car position, we align the y-axis of the point cloud with the car moving direction, and hence road width is aligned along the x-axis. Furthermore, the point cloud axis origin is shifted to the current camera position. Here, we shall assume that road is detected by using the above procedure. We create a binary mask by retaining the detected road. We start working with the foreground mask Q_{f} which is generated in P-1 of step 8 above. All segments of Q_{f} are identified as primary candidates for road marking.

Due to noise effects, the foreground image may have false road markings. Furthermore, the road can have some other markings which are not related to lanes, for example the speed-limit can be marked on road. In this section, we first develop a procedure to detect possible lane centre on x-axis. Second, we shall distinguish the true lane markings from false samples.

### Rectification-I

Consider a straight road segment. Given the foreground mask Q_{f} and detected road, we first extract all possible markings candidates that are on the road, see FIG. 7 (c). We then generate a binary mask by using the marking candidates. Project the nonzero pixels on x-axis. This will create an 1D vector. Since the road is straight, true lane markings are almost vertical to x-axis. Consequently, the projected vector will produce sharp local peaks around the centre of true lane markings. See FIG. 7 (d). However, due to noise effect we may find false peaks. We identify true peaks by using the following two steps.

Cat-I: Identify Confidant Lane Markings

We can be confident lane markings are very tall in y-direction. They generally create road divider marking, left and right road boundary markings etc. We characterize them by the following properties:

Property-I: The projected lane marking peak amplitude is generally high. In our algorithm, we consider peak height threshold 10.0 meter. Since point cloud to image grid resolution is taken 0.075 meter (see step 7 of road identification) this corresponds to 133 pixels in image (for the data we are using in this example).

In FIG. 45: (a) Camera image around the location of interest; (b) Threshold gradient image of point cloud; (c) Road marking candidates extracted; (d) Projection of road marking on x-axis; (e) Large lane markings are detected; (f) All possible lane markings are detected.

In FIG. 45 (d) Peak-1, Peak-3 and Peak-4 satisfy the property.

Property-II: The peak is sharp. The sharpness of a peak is measured by its width at half height. Peak width threshold is set to 1.0 meter.

### Cat-II: Identify Small Lane Markings

Small sized lane markings are characterized by the following properties:

Property-I: Peak amplitude are moderate. In our algorithm we consider peak heights threshold 2.0 meter.

Property-II: The peak is sharp. Peak width threshold is set to 1.0 meter.

Property-III: (Tracking property): In many cases, multiple small lane markings are aligned on a common curve. In a straight road, the curvature of the curve is straight and almost perpendicular to the x-axis. Therefore, the peak centre of projected road markings on x-axis will remain almost the same for successive frames. Suppose we have prior knowledge about possible centre location of lane marking. Then we search for relatively small peak magnitude around the prior lane centre.

### Curved Road

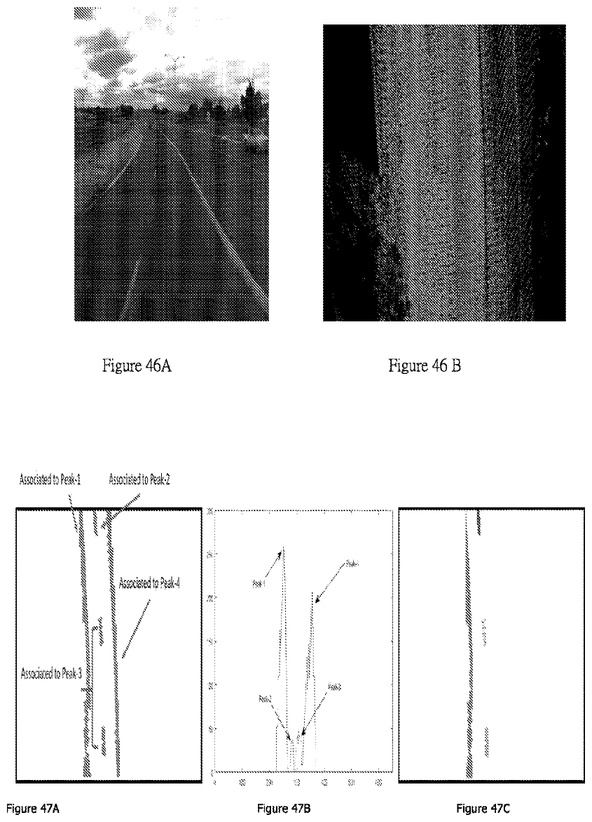

The algorithm described works well provided that the road segment is straight. However, for curved road, it generates false lane centres. For example see FIGS. 46 and 47.

FIG. 46A shows a camera image around the location of interest, and 46B the threshold gradient image of the point cloud. The car azimuth angle difference between current frame and 2nd next frame is −3.845 degree. FIG. 47A shows Road marking candidates extracted; 47B shows projection of road marking on x-axis; and 47C shows all possible lane markings are detected.

The projection of marking mask is shown in FIG. 47B. Although, the road has three lane centres, it produces four peaks. Peak-1 satisfies Cat-I property as described above, however, Peak-4 is failed due to its large peak width. Again, Peak-2 satisfies Cat-II properties, and Peak-3 satisfies Property-III of Cat-II. Therefore, we get two independent lane centre for Cat-II, which should be one.

Generally, curve tracking methods are used to find out lane markings in this type of road. However, curve tracking cannot perform well in many cases, for example if a new lane starts at the middle of road, or some of the lane marking are invisible in previous road segments. Here we develop a procedure to identify lane centres more reliably. The main idea is performing a transformation of the road marking mask image that aligns the lane makings, that are associated to a lane, into a straight line and approximately perpendicular to x-axis. As explained above, we have information about the azimuth (heading) angle of the car positions. For a given car reference position, we align the point cloud data y-axis to the azimuth angle of car position (see pre-procession steps discussed above.

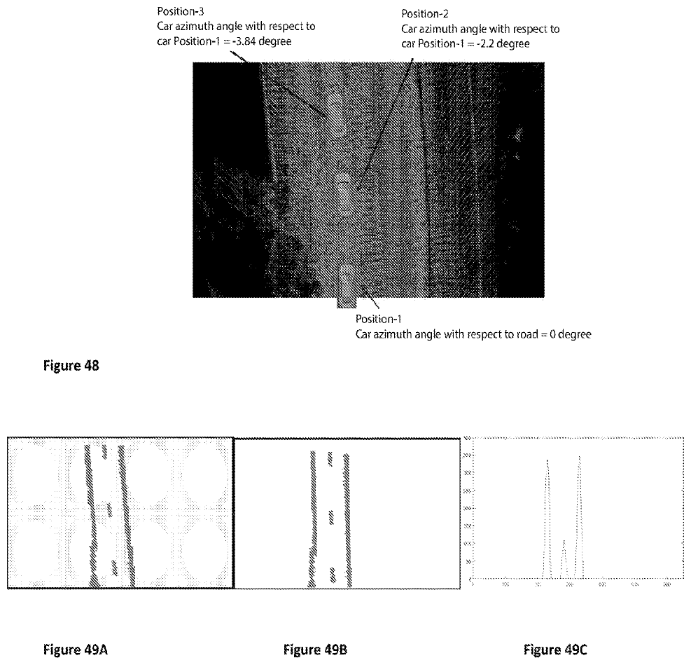

In FIG. 48 we show car azimuth (heading) angles for three different positions.

Here Position-1 is reference position, therefore, azimuth angle related to the bottom part of road direction is 0 degree. The azimuth angle difference of Position-2 from Position-1 is −2.2 degree. The car is heading towards the road direction in Position-2. Hence the road bending angle at Position-2 with respect to Position-1 is −2.2 degree. Similarly, the road bending angle at Position-3 with respect to Position-1 is −3.84 degree. The above observation implies that we have to rotate the road marking mask in an adaptive way. The bottom part of the image requires no rotation, then, gradually apply rotation on the mask 0 degree to −3.84 degree from bottom to top of the image.

The adaptive rotation process can be explained in the following way. Let top part of the image require 0 degree rotation and the image has N rows and M columns. Then by initial adaptive rotation the pixel at n-th row and m-th column will be moved to (\hat{n}, \hat{m}):

$$[ \begin{matrix}\hat{n} \\ \hat{m}\end{matrix} ] = {R}_{\hat{θ}} [ \begin{matrix}n \\ m\end{matrix} ] \qquad ( 1.16 )$$

where,

$${R}_{\hat{θ}} = [ \begin{matrix}cos ( \hat{θ} ) & - sin ( \hat{θ} ) \\ sin ( \hat{θ} ) & cos ( \hat{θ} )\end{matrix} ] and , \hat{θ} = \frac{θ ( N - n )}{N} . \qquad ( 1.17 )$$

FIG. 49A shows the initial adaptive rotation of primary road marking candidate (from FIG. 47) by −3.845 degree; 49B shows the final adaptive rotation of the primary road marking candidate by −3.845 degree, and 49C shows the projection of the road marking on x-axis.

FIG. 49A shows the mask rotation after applying the initial adaptive rotation. The lane markings are aligned along to straight lines, however, they are not perpendicular to the x-axis. In particular the straight lines angle is θ degree with respect to vertical axis. We need another rotation of the mask by the fixed angle of θ i.e.,

$$[ \begin{matrix}\tilde{n} \\ \tilde{m}\end{matrix} ] = {R}_{θ} [ \begin{matrix}\hat{n} \\ \hat{m}\end{matrix} ] \qquad ( 1.18 )$$

The final output of adaptive rotation is shown in FIG. 49B. The related lane peaks are shown in FIG. 49C. We can easily identify lane centres. Note that we need not to do two independent steps i.e., (1.16 and 1.18) and for adaptive rotation. We can do this in one step. In equation (1.16) we need to replace \tilde{θ} by θ+\tilde{θ}.

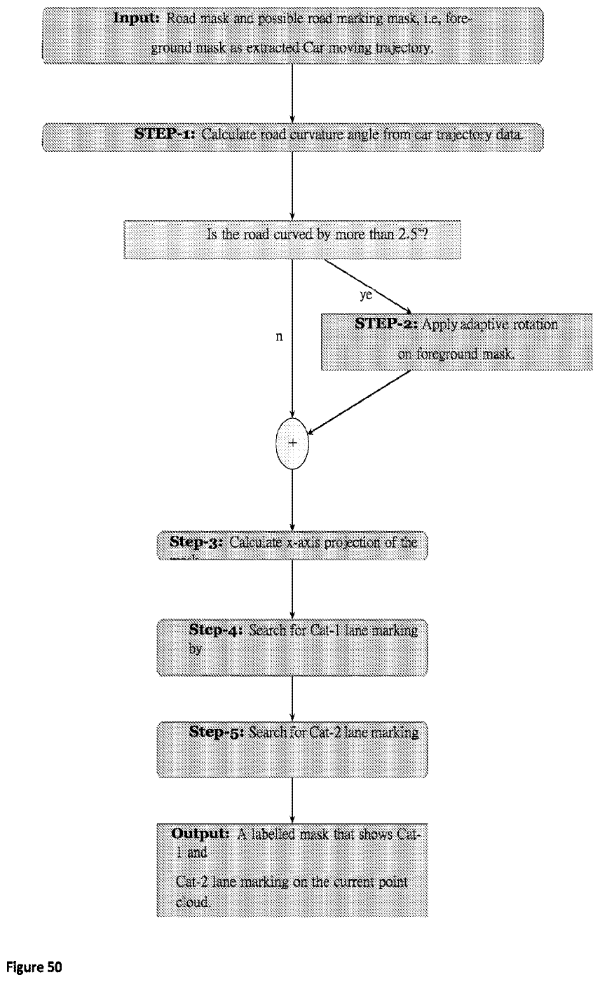

The lane marking detection algorithm is summarized in FIG. 50.

d) Alternative Camera Image and Point Cloud Data Fusion System:

We describe elsewhere in this description some algorithms that can classify image data and point cloud data independently. Here we describe a procedure that can transfer image classification results to point cloud and generate a better classified point cloud.

Our image classification algorithm (as explained further below) can detect street-lights and different types of safety walls effectively. However, it cannot extract actual physical distance of the classified objects from the surveillance car. Our point cloud classification algorithm can classify some objects which are difficult to identify from the image data. Following we describe a method to combine both types of data and generate an improved classified point cloud.

### Data Projection System

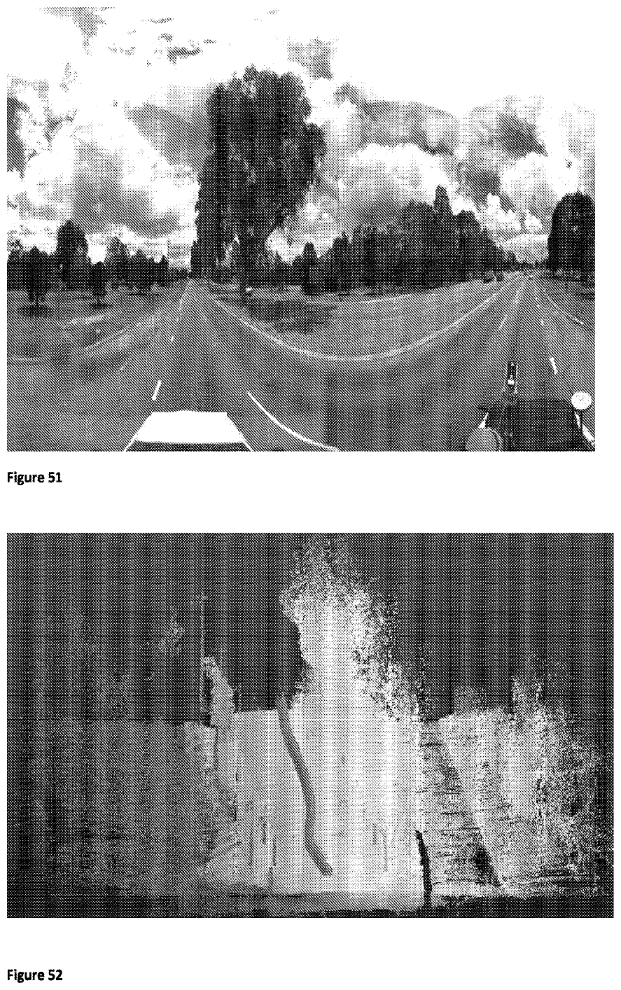

The image data in this implementation is collected by using a camera with 5 lenses. The lenses are oriented at different directions relative to the car. At a particular time, the camera takes 5 snapshots simultaneously. The resulting images are stitched together to produce a 360° panorama image. FIG. 51 shows an example of such a 360° spherical image.

Point cloud data are collected by using a mobile LiDAR. The point cloud data is given in real world coordinates. FIG. 52 shows an example.

For the purpose of effective data fusion, we must work on a common coordinate system. For this reason, we project the point cloud data to spherical coordinate system. We convert each point p=[x, y, z]^{T} of the point cloud to spherical coordinate via a mapping II: [symbol] ³→ [symbol] ², which is defined by:

$$[ \begin{matrix}u \\ v\end{matrix} ] = [ \begin{matrix}\frac{1}{2} [ 1 - arctan ( y , x ) {π}^{- 1} ] ω \\ ( 1 - ( arcsin \text{?} + {f}_{up} ) {f}^{- 1} ) h\end{matrix} ] \qquad ( 1.19 )$$

$$\text{?} \text{indicates text missing or illegible when filed}$$

where (u, v) are associated image coordinates, (h, ω) are the height and width of the desired range image representation, f=fᵤₚ+f_{down} is the vertical field-of-view of the LiDAR sensor, and r=\sqrt{x²+y²+z²}:=∥p∥₂ is the range of each point. This procedure results in a list of (u, v) tuples containing a pair of image coordinates for each p.

Suppose we want to project a classified point cloud to image coordinates by using (1.19). Every image location (u, v) needs to be assigned with a classification label. However, by (1.19), multiple points of cloud can be projected onto the same image coordinates. Suppose n different points {pᵢ}ᵢ₌₁ⁿ are projected to (u,v). The classification labels associated to those n cloud points are {Lᵢ}ᵢ₌₁ⁿ.

Let k=arg min ∥pᵢ∥₂, i={1, 2, . . . n}. Then the image location (u, v) will be assigned with the classification label Lₖ. By using a similar pro-cedure, we can generate range (depth) map image from point cloud data. It uses the same projection as in (1.19), only the pixel value at (u, v) is ∥pₖ∥₂.

If we want to use the projection method (1.19) for camera image and point cloud fusion, then we need to align the point cloud with camera orientation. Let the camera location in world coordinate system at time t be (x_{c,t}, y_{c,t}, z_{c,t}). The LiDAR and camera are mounted at two different locations on the surveillance car. The pitch, roll, and yaw angle of camera changes with the movement of the car.

Let the position shift of the LiDAR optical centre with respect to camera centre be (x₀, y₀, z₀). At time t, the roll, pitch, and yaw angles of camera centre are θ_{x,t}, θ_{y,t} and θ_{z,t} respectively. We assume that the values of those parameters are known approximately. In particular, we assume that camera position can be estimated using GPS and the angles can be estimated from the car's inertial measurement unit (IMU). An IMU is an electronic device that measures and reports a body's specific force, angular rate, and sometimes the orientation of the body, using a combination of accelerometers, gyroscopes, and sometimes magnetometers.

Consider a point [\hat{x}, ŷ, \hat{z}]^{T} in the point cloud. We need the following transformation before projecting cloud point to image domain:

$$[ \begin{matrix}x \\ y \\ z\end{matrix} ] = {R}_{z} ( {θ}_{z , t} ) {R}_{y} ( {θ}_{y , t} ) {R}_{x} ( {θ}_{x , t} ) [ \begin{matrix}x - {x}_{c , t} - {x}_{0} \\ \text{?} \\ \text{?}\end{matrix} ] \qquad ( 1.2 )$$

$$\text{?} \text{indicates text missing or illegible when filed}$$

where Rₓ(θₓ) is a rotation matrix that rotate a 3 d point about x-axis by θₓ angles. R_{y}(θ_{y}) and R_{z}(θ_{z}) are defined similarly.

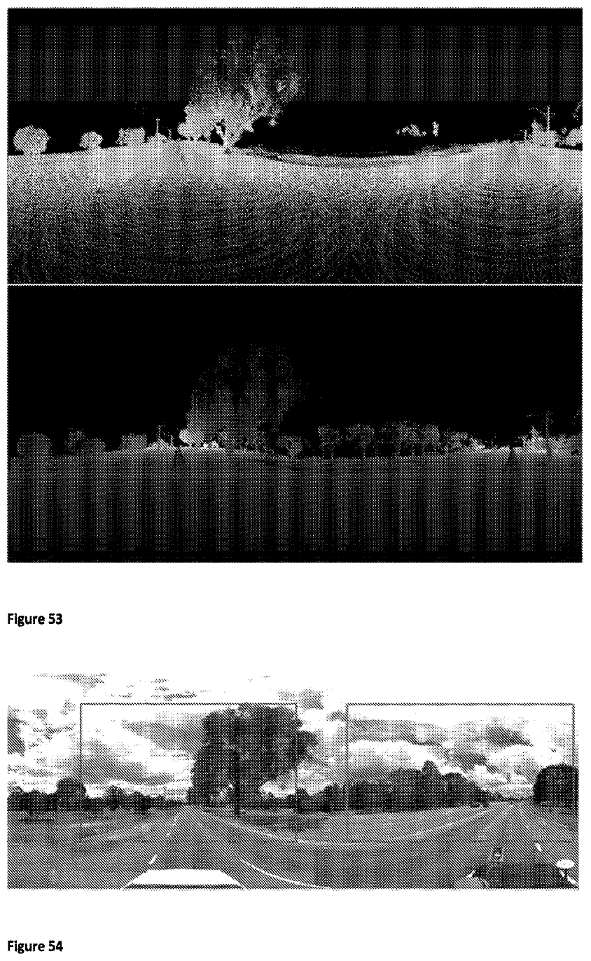

FIG. 53 shows an example. Point cloud data is projected on spherical image coordinates. The top image shows projection of classified point cloud data, the bottom image shows projection of range data.

We now describe some challenges that arise when we transfer image data to the projected point cloud and vice versa. The primary requirement for transferring data is the alignment of projected point cloud and image data. The alignment may not be perfect for many reasons.

### Working Area of Camera Image Data

The underlying camera imaging system takes multiple snapshots at a particular time. Those are stitched together to produce a spherical image, as shown for example in FIG. 51. Due to spherical transformation, the middle part of the image is deformed significantly. The image classification at this area is difficult. Therefore, we use the left and right parts of the image for classification and mapping. The areas are bounded by boxes, as can be seen in FIG. 54. This shows point cloud data in the world coordinate system. Note that left box is in front of the surveillance car, whereas the right box is behind the car.

### Mis-Alignment of Camera Image and Point Cloud Projected Data

We apply the transformation in (1.20) before point cloud projection. We assume that (x_{c,t}, y_{c,t}, z_{c,t}) and θ_{x,t}, θ_{y,t}, and θ_{z,t}, are known. In practice, those values cannot be estimated exactly due to car movement. This uncertainty creates mis-alignment of camera image and projected point cloud image.

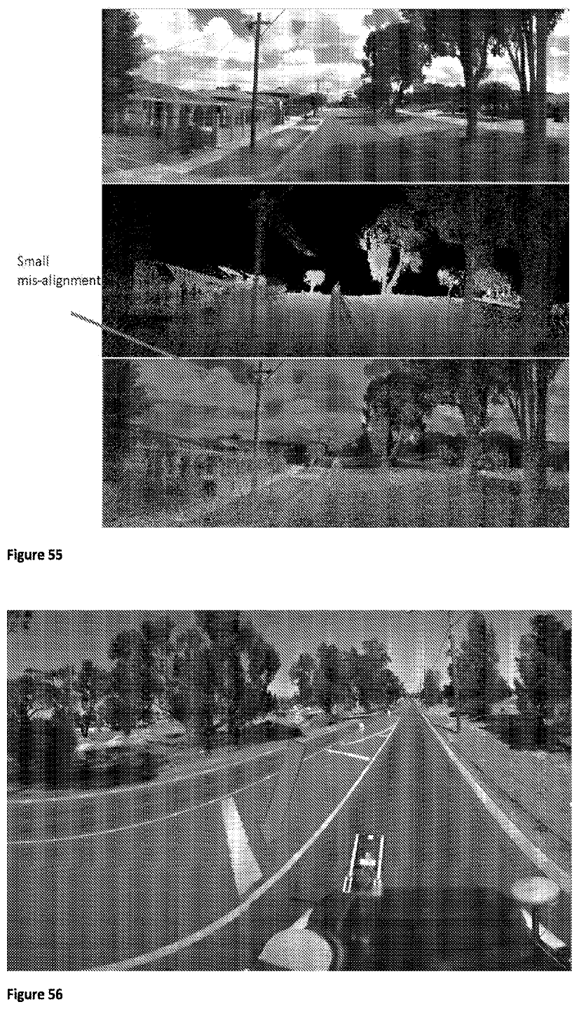

FIG. 55 shows a at top the camera image, middle, the point cloud projected image, and bottom the overlapping projected image on camera image. We see that the point cloud projected image is aligned almost perfectly with the camera image with a small mis-alignment.

### Effect of Conversion of Camera Image to Spherical Image

The stitching of multiple images to create single spherical results in discontinuous image. For example, the image in FIG. 56 shows (at the arrow) a region where the images have not been properly stitched together.

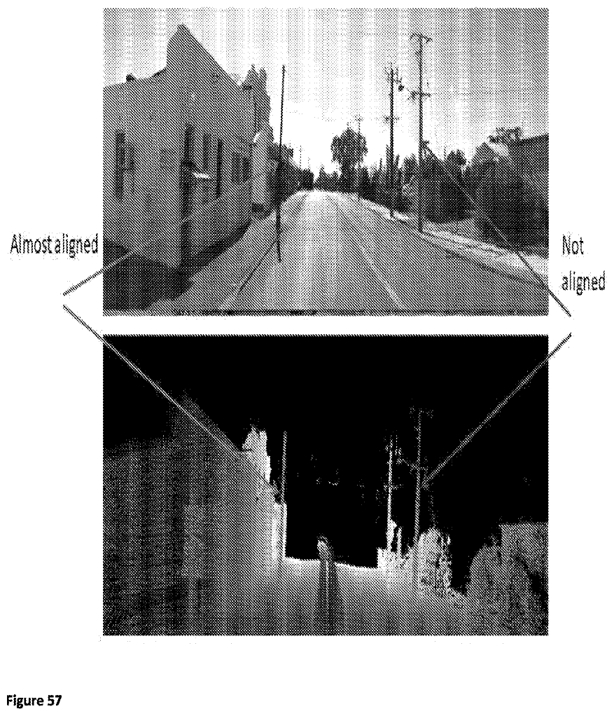

This type of deformation creates a big problem for data alignment. FIG. 57 shows an example of unbalanced alignment of image data with point cloud projected data. The pole on the left side of the image is almost aligned to the point cloud projected data. However, the pole on right side is somewhat misaligned.

### Camera Image and Point Cloud Projected Image Alignment

Equation (1.20) shows that point cloud data requires some transformations before performing the projection onto the image domain. The transformation depends on 6 parameters:
Camera location in world coordinate system: (x_{c,t}, y_{c,t}, z_{c,t}).
Camera roll, pitch, and yaw angles: (θ_{x,t}, θ_{y,t}, θ_{z,t}).

However, we cannot measure these quantities exactly due to movement noise. The measurement noise can be modelled as a zero mean Gaussian random noise with some variance. Let σ₀ be the noise variance for (x_{c,t}, y_{c,t}, z_{c,t}) and or, be the noise variance for (θ_{x,t}, θ_{y,t}, θ_{z,t}). Now the transformation system in (2) can be written as

$$[ \begin{matrix}x \\ y \\ z\end{matrix} ] = {R}_{z} ( {θ}_{z , t} + δ {w}_{t} ) {R}_{y} ( {θ}_{y , t} + δ {v}_{t} ) {R}_{x} ( {θ}_{x , t} + δ {u}_{t} ) [ \begin{matrix}\hat{x} - {x}_{c , t} - {x}_{0} - δ {x}_{t} \\ \hat{y} - {y}_{c , t} - {y}_{0} - δ {y}_{t} \\ \hat{z} - {z}_{c , t} - {z}_{0} - δ {z}_{t}\end{matrix} ] \qquad ( 1.21 )$$

where (δuₜ, δvₜ, δwₜ, δxₜ, δyₜ, δzₜ) are noise parameters which we need to estimate.

In particular, δuₜ, δvₜ, δwₜ have variance σ₀ and δxₜ, δyₜ, δzₜ have variance σₐ. The values of σ₀ and σₐ are estimated by using manual tuning. We select some sample camera images and associated point cloud data. For every image, we tune the values of (δuₜ, δvₜ, δwₜ, δxₜ, δyₜ, δzₜ) such that the projected point cloud data is aligned maximally with the camera image. Based on the tuned parameter values, we estimate σ₀ and σₐ.

### The Tuning and Estimation Process is as Follows:

Input: Every dataset comes as a large point cloud and many camera images that are captured at some given locations. Every camera location is associated with a location (x, y, z) and pitch, roll and yaw angle information.

Step-1: Select some camera images randomly. Suppose we select N images.
Step-2: For every selected image n=1, 2, . . . N; do the following:

Step-2.1: Given (x,y,z) associated to the n-th camera location, select a point cloud slice around it.

Step-2.2: Project the point cloud to spherical image coordinates by using the process described earlier. Let the resultant image be Ip

Step-2.3: Try to align the n-th camera image with Ip. If they are not aligned then tune δut, δvt, δwt, δxt, δyt, δzt and apply the process described with reference to equation 1.21.

Step-2.4: When the n-th camera image and Ip are aligned maximally then store the tuned value as {(δut)ₙ, (δvt)ₙ, (δwt)ₙ, (δxt)ₙ, (δyt)ₙ, (δzt)ₙ}

Step-3: Estimate σ₀ and σₐ:

$$m 1 = \frac{1}{3 N} {\sum }_{n = 1}^{N} ( {( δ ut )}_{n} + {( δ vt )}_{n} + {( δ wt )}_{n} )$$

$${σ}_{0} = \frac{1}{3 N} {\sum }_{n = 1}^{N} ( {( {( δ ut )}_{n} - m 1 )}^{2} ) + ( {( {( δ vt )}_{n} - m 1 )}^{2} ) + ( {( {( δ wt )}_{n} - m 1 )}^{2} )$$

Using a similar procedure calculate σₐ from (δxt)ₙ, (δyt)ₙ, (δzt)ₙ.

To fix the unbalanced alignment error as described around FIG. 55, we need additional steps. In particular, two different sets of alignment parameters are required for left and right side of the image.

### Principle of Alignment

Suppose, at time t, we have a classified mask from camera image and a classified mask from point cloud.

Select some reference objects which are common in both masks.

Create two reference masks by retaining the selected objects from camera image and point cloud data.
Tune the values of (δuₜ, δvₜ, δwₜ, δxₜ, δyₜ, δzₜ) such that both masks are aligned maximally.

### Reference Object Selection

Automatic reference object selection is very difficult. Hence, we apply an alternative procedure. Suppose our algorithm detects N different classes from image and point cloud. The class can be, for example, poles, trees, buildings etc. Let the class-n have the highest probability of detection from both image and point cloud. Now consider the alignment problem at time t. We project the classified point cloud to spherical coordinate by using car position (x_{c,t}, y_{c,t}, z_{c,t}) and (θ_{x,t}, θ_{y,t}, θ_{z,t}) (see (1.19) and (1.20)).

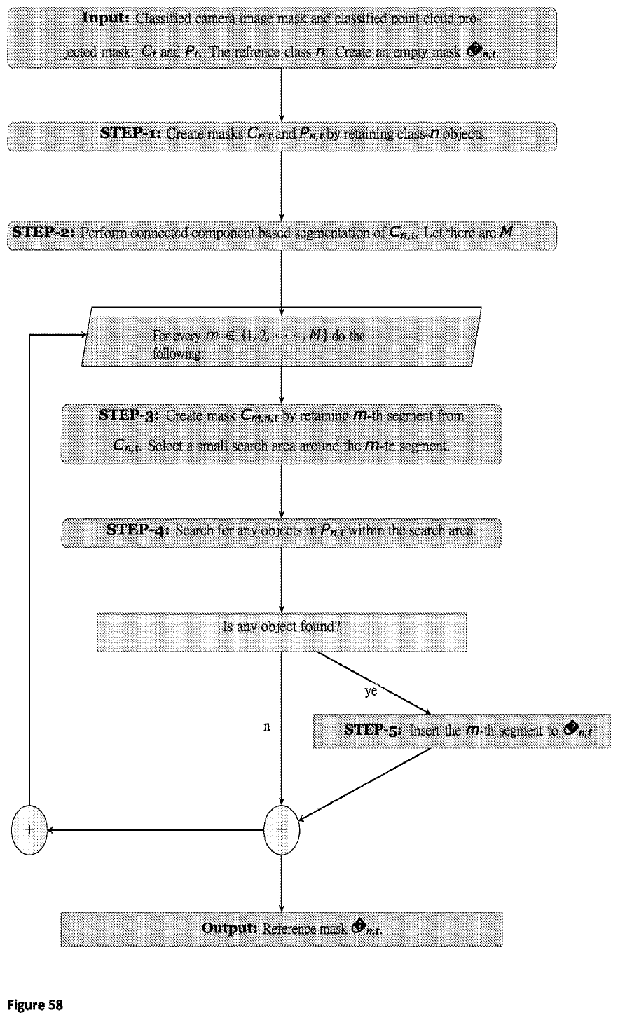

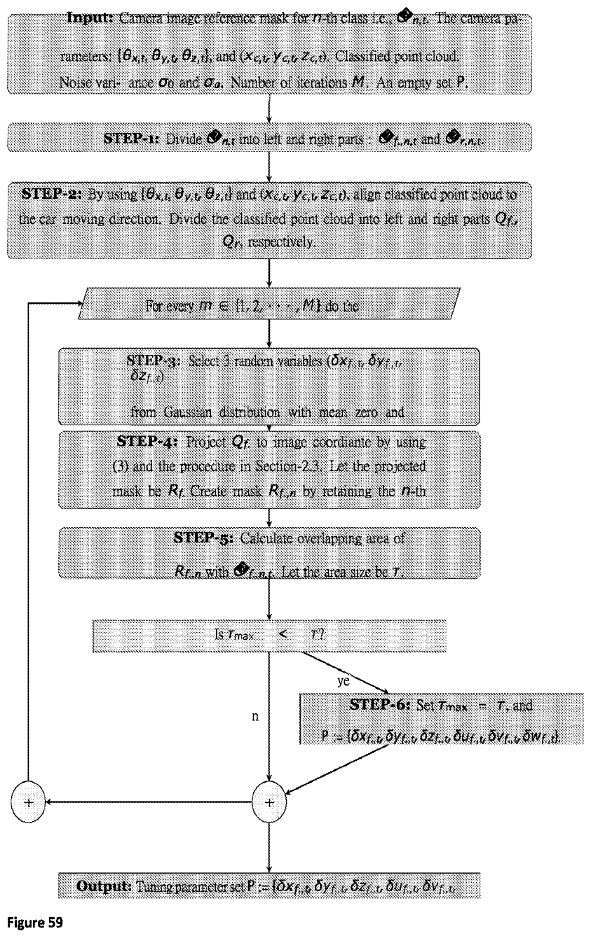

The classified camera image mask and point cloud projected image mask at this time are Cₜ and Pₜ respectively. Suppose the class n object is present in both masks. Create masks C_{n,t} and P_{n,t} by retaining the class-n objects. Perform connected component based segmentation of C_{n,t}. Let there be M segments. For the m-th segment, select a small search area around it. Now check if any object exists within the search area in P_{n,t}. If we find any objects for m=1, 2, . . . M, then C_{n,t} and P_{n,t} will be selected as reference mask set. This algorithm is described in the flowchart of FIG. 58.

Note that at a particular time instant, there may not exist any object of class-n in the scene. As a result, C_{n,t} and P_{n,t} will be empty. To get around the issue, we consider multiple object-classes for reference mask creation. In particular, we select 3 classes in our implementation. The most preferable class is the set of poles. The next are buildings and trees respectively.

### Projection Alignment

At time t, we have created camera image reference mask for n-th class Ĉ_{n,t}. We have to select the optimum value for (δuₜ, δvₜ, δwₜ, δxₜ, δyₜ, δzₜ) so that the point cloud projected mask of n-th class will align maximally with Ĉ_{n,t}. The projection method involves a nonconvex search as described in relation to spherical projection of LiDAR.

It is difficult to design an optimization algorithm for finding these parameters. We apply a random sampling method to obtain sub-optimal result. The algorithm is described in FIG. 59. To handle the unbalanced mis-alignment, (see description and FIG. 57), we divide the image mask and point cloud into left and right parts. Then search for the parameters (δuₜ, δvₜ, δwₜ, δxₜ, δyₜ, δzₜ) for left and right parts independently. Step-2 to Step-6, shows the searching process for left hand side only. The same process is repeated for the right hand side.

The disclosures of all the references noted, including all the references in the bibliography, are hereby incorporated by reference. References in [ ] are to the corresponding document in the bibliography.

The present invention is described at the level of those experienced in data analysis and, as such, the details of implementation and coding will be well known and will not be described. These are conventional once the principles described above are applied.

Variations and additions are possible to the various aspects of the present invention, for example and without limitation additional processing or pre-processing steps, improved algorithms for specific processing stages, or alternative or additional data filtering. All the various aspects of the invention described may be implemented in their entirety, or only certain aspects. For example, the tree and road detection components could be applied to point cloud and image data with a road surface identified using alternative techniques, or simply to a stored data set.

1. A method for processing image data to automatically identify a road, including at least the steps of:
a) Generating a top view image of a landscape from 360 degree imagery including a road, and data indicating the location of a camera that generated the image;
b) Detecting lines generally parallel to the expected road direction
c) Determining the x-centre of the detected lines;
d) Segmenting the image using the detected lines and x-centres into segments;
e) Classifying the segments as road, divider or other using the segment on which the camera was located as a first road segment, and using the colour data relating to the other segments to classify them as part of the road, or as other features.

2. A method according to claim 1, wherein the image data is taken from a generally horizontal plane and transformed to provide a top view image.

3. A method according to claim 1, wherein the colour data includes hue and saturation data, and where the segments with hue and saturation more indicative of surrounding terrain are excluded as road segments.

4. A method for converting image data to 3D point cloud data, the camera image data including a successive of images taken at regular distance intervals from a vehicle, and in which the image data includes the azimuth angle of the vehicle position relative to the y axis of the point cloud data for each image, the method including the steps of:
a) For the i-th camera image, convert the image data to a the point cloud domain to produce a first point cloud;
b) Rotate the associated cloud points by the azimuth angle of the car position;
c) Select cloud points from a small predetermined distance d along y-axis in front of car location, corresponding to the distance travelled between images, to form first cloud point data;
d) For the i+1th image, repeat steps a to c to generate second point cloud data;
e) Repeat step d for a predetermined number n of images;
f) Combine the first point cloud data with the second point cloud data, displaced distance d along the y axis, and repeat for the following n images.

5. A method for automatically identifying road segments from vehicle generated point cloud data, the method including the steps of:
a) Down sampling the point cloud data to form a voxelised grid;
b) Slicing the point cloud data into small sections, corresponding to a predetermined distance along the direction of travel of the vehicle;
c) Perform primary road classification using a RANSAC based plane fitting process, so as to generate a set of road plane candidates;
d) Apply a constrained planar cuts process to the road plane candidates, to generate a set of segments;
e) Project point cloud onto the z=0 plane;
f) Identify a parent segment using a known position of the vehicle, which is presumptively on the road;
g) Calculate the width of the parent segment along the x axis, and compare to a known nominal road width;
h) If the segment is greater than or equal to nominal road width, and if it is greater than a predetermined length along the y axis; then this is the road segment;
i) If not, then add adjacent segments until the condition of (h) is met, so as to define the road segment.

6. A method for automatically detecting roadside poles in point cloud data, including the steps of:
a) Filtering the point cloud data, so as to remove all data below a predetermined height above a road plane in said point cloud data;
b) Perform Euclidian distance based clustering to identify clusters which may be poles;
c) Apply a RANSAC based algorithm to detect which of the clusters are cylindrical;
d) Filter the cylindrical candidates based on their tilt angle and radius;
e) Process a set of image data corresponding to the point cloud data, so as to identify pole objects;
f) Match the cylindrical candidates to the corresponding pole objects, so as to identify in the point cloud data.

7. A process according to claim 6, wherein the image data is processed so as to identify pole objects, and only the image data relating to the pole objects is transferred to produce corresponding point cloud data,

8. A method for detecting roadside trees in point cloud data, including the steps of
a) Filtering the point cloud data, so as to remove all data below a predetermined height above a road plane in said point cloud data;
b) Segmenting the filtered point cloud data to identify locally convex segments separated by concave borders;
c) Applying a feature extraction algorithm to the local segments, preferably viewpoint feature histogram, in order to identify the trees in the point cloud data.

9. A method for processing vehicle generated point cloud data and corresponding image data to facilitate feature identification, wherein the image data is captured sequentially a known distance after the previous image along the direction of travel, the method including the steps of:
a) Down sampling the point cloud data to form a voxelised grid;
b) Slicing the point cloud data into small sections, each section relating to the distance along the direction of travel between the first and last of a small number of sequential images along the direction of travel of the vehicle;
c) Thereby reducing the size of the point cloud data set to be matched to the small number of images for later feature identification.
